(19) United States
(12) Patent Application Publication
(10) Pub. No.: US 2026/0281465 A1
(43) Pub. Date: Sep. 17, 2026

(54) VIDEO-BASED ANALYTICS PLATFORM FOR REAL-TIME TRACKING OF ATHLETE AND EQUIPMENT MOVEMENT

(71) Applicants: ROBERT BRADLEY BURKHART, AGOURA HILLS, CA (US); PETER CHRISTIAN MAURER, SHERMAN OAKS, CA (US); EDMOND DEFRANK, Northridge, CA (US)

(72) Inventors: ROBERT BRADLEY BURKHART, AGOURA HILLS, CA (US); PETER CHRISTIAN MAURER, SHERMAN OAKS, CA (US); EDMOND DEFRANK, Northridge, CA (US)

(21) Appl. No.: 19/675,022

(22) Filed: May 12, 2026

Related U.S. Application Data
(63) Continuation-in-part of application No. 19/351,834, filed on Oct. 7, 2025, now Pat. No. 12,627,844.
Application No. 19/351,834 is a continuation-in-part of application No. 19/206,875, filed on May 13, 2025, now Pat. No. 12,439,098.
Application No. 19/206,875 is a continuation of application No. 18/761,276, filed on Jul. 1, 2024, now Pat. No. 12,301,892.
Application No. 18/761,276 is a continuation of application No. 18/401,487, filed on Dec. 30, 2023, now Pat. No. 12,028,557.
Application No. 18/401,487 is a continuation of application No. 18/208,368, filed on Jun. 12, 2023, now Pat. No. 11,863,800.
Application No. 18/761,276 is a continuation of application No. 18/208,368, filed on Jun. 12, 2023, now Pat. No. 11,863,800.
Application No. 18/208,368 is a continuation of application No. 17/977,998, filed on Oct. 31, 2022, now Pat. No. 11,677,990.
Application No. 17/977,998 is a continuation of application No. 17/374,874, filed on Jul. 13, 2021, now Pat. No. 11,490,130.
Application No. 17/374,874 is a continuation of application No. 16/199,175, filed on Nov. 24, 2018, now Pat. No. 11,064,221.

(51) Int. Cl. H04N 21/218; H04N 7/18; H04N 21/2187; H04N 21/81; H04N 21/8549

(52) U.S. Cl. CPC H04N 21/21805; H04N 7/181; H04N 21/2187; H04N 21/812; H04N 21/8549

(57) ABSTRACT

The embodiments discloses at least two mobile devices of at least two users, each having a mobile application operating a video camera, wherein each video camera captures at least two different viewpoints of video footage of a same live event, wherein the mobile applications on each mobile device is configured to coordinate the viewpoints of the video footage and present multi-camera viewpoints and live-streaming video footage of the live event to remote users and an ad server configured to target advertisements to the remote users during the live-streaming of the live event.

### CROSS-REFERENCE TO RELATED APPLICATIONS

This Patent Application is a Continuation-in-part and claims priority to United States Patent Application entitled: “VIDEO-BASED ANALYTICS PLATFORM FOR REAL-TIME TRACKING OF ATHLETE AND EQUIPMENT MOVEMENT”, U.S. Ser. No. 19/351,834 filed on Oct. 7, 2025 by Robert Bradley Burkhart, which is a Continuation-in-part and claims priority to United States Patent Application entitled: “VIDEO-BASED ANALYTICS PLATFORM FOR REAL-TIME TRACKING OF ATHLETE AND EQUIPMENT MOVEMENT”, U.S. Ser. No. 19/206,875 filed on May 13, 2025 by Robert Bradley Burkhart, which is a Continuation of and claims priority to United States Patent Application entitled: “MULTI-CAMERA LIVE-STREAMING METHOD AND DEVICES”, U.S. Ser. No. 18/761,276 filed on Jul. 1, 2024 filed by Robert Bradley Burkhart, which is a Continuation of and claims priority to United States Patent Application entitled: “MULTI-CAMERA LIVE-STREAMING METHOD AND DEVICES”, U.S. Ser. No. 18/401,487 filed on Dec. 30, 2023 filed by Robert Bradley Burkhart, which is a Continuation of and claims priority to United States Patent Application entitled: “MULTI-CAMERA LIVE-STREAMING METHOD AND DEVICES”, U.S. Ser. No. 18/208,368 filed on Jun. 12, 2023 filed by Robert Bradley Burkhart, which is a Continuation of and claims priority to United States Patent Application entitled: “MULTI-CAMERA LIVE-STREAMING METHOD AND DEVICES”, U.S. Ser. No. 17/977,998 filed on Oct. 31, 2022 filed by Robert Bradley Burkhart U.S. Pat. No. 11,677,990 issued on Jun. 13, 2023, which is a Continuation of and claims priority to United States Patent Application entitled: “MULTI-CAMERA LIVE-STREAMING METHOD AND DEVICES”, U.S. Ser. No. 17/374,874 filed on Oct. 31, 2022 filed by Robert Bradley Burkhart U.S. Pat. No. 11,490,130 issued on Nov. 1, 2022, which is a Continuation of and claims priority to United States Patent Application entitled: “MULTI-CAMERA LIVE-STREAMING METHOD AND DEVICES”, U.S. Ser. No. 16/199,175 filed on Nov. 24, 2018 filed by Robert Bradley Burkhart U.S. Pat. No. 11,064,221 issued on Jul. 13, 2021, all of the above cases being incorporated herein by reference.

### BACKGROUND

Live event broadcasting and sports related media content represent a significant and growing market for digital streaming, analytics, and interactive viewer engagement. Participants, coaches, recruiters, broadcasters, analysts, and spectators increasingly desire access to high quality video coverage, replay functionality, and real time event analysis. However, conventional single camera capture systems often provide limited viewing angles, incomplete coverage of fast moving action, and reduced situational awareness during live events. A single fixed camera generally cannot provide the immersive viewing experience associated with modern professional multi camera broadcast productions. Multi camera capture systems provide synchronized viewpoints, enhanced replay capability, and dynamic scene coverage that more closely emulate professional broadcast environments while enabling advanced analytics, automated event detection, and interactive viewing experiences.

### SUMMARY

The present disclosure relates generally to synchronized multi camera video capture systems, artificial intelligence based analytics, computer vision processing, spatial tracking, automated event recognition, and interactive media generation for professional and competitive sporting events. More particularly, the disclosed systems and methods relate to distributed camera and sensor networks configured to capture synchronized video streams and associated telemetry data from multiple viewpoints and process the captured imagery and sensor information using artificial intelligence, machine learning, computer vision, predictive analytics, and spatial reconstruction frameworks to generate enhanced live broadcasts, automated officiating assistance, player and equipment tracking, immersive replay environments, interactive viewer experiences, and real time performance analytics. The disclosed systems improve the technical operation of distributed video processing systems by performing synchronized multi source image acquisition, frame aligned spatial analysis, automated event detection, distributed inference processing, and adaptive low latency media rendering across geographically distributed computing infrastructures.

In certain embodiments, the disclosed system includes a plurality of network connected imaging devices positioned throughout a sports venue to capture overlapping video streams of players, officials, spectators, and sports equipment from multiple synchronized viewpoints. The imaging devices may include fixed cameras, pan tilt zoom cameras, ultra high speed cameras, depth sensing cameras, infrared cameras, stereoscopic cameras, thermal imaging devices, wearable cameras, aerial drone cameras, robotic cameras, body mounted cameras, mobile devices, lidar systems, radar sensors, time of flight sensors, ultrasonic sensors, inertial measurement units, accelerometers, gyroscopes, magnetometers, GPS devices, environmental sensors, microphones, directional audio arrays, and other optical or electronic sensing devices configured to capture visual, positional, motion, spatial, biometric, or environmental data associated with a live sporting event. The imaging devices may include optical lenses, image sensors, complementary metal oxide semiconductor sensors, charge coupled device sensors, digital signal processors, onboard graphics processors, hardware encoders, wireless communication modules, and embedded memory systems configured to locally process and transmit captured image data.

In certain embodiments, the imaging devices communicate through wired or wireless communication infrastructures including cellular communication systems, fifth generation communication networks, sixth generation communication networks, Wi Fi communication systems, mesh communication systems, millimeter wave communication systems, satellite communication systems, fiber optic communication systems, ethernet communication systems, radio frequency communication systems, microwave transmission systems, and software defined networking architectures. The camera systems may be synchronized using timing reference systems including network time protocol synchronization, precision time protocol synchronization, frame synchronization pulses, timestamp metadata, GPS timing signals, atomic clock synchronization systems, phase locked synchronization systems, or distributed clock alignment architectures configured to maintain frame accurate synchronization between multiple video streams and telemetry sources. The synchronization subsystem may continuously compensate for network latency, clock drift, packet loss, transmission jitter, frame misalignment, and communication interruptions through adaptive correction algorithms and predictive buffering systems.

The captured video streams, telemetry data, sensor measurements, and positional information may be processed by one or more digital processors, cloud computing systems, edge computing systems, graphics processing units, tensor processing units, field programmable gate arrays, neural processing units, application specific integrated circuits, multicore processors, distributed server clusters, or parallel inference engines configured to execute computer vision and artificial intelligence operations in real time.

The disclosed system may further include digital memory systems, solid state storage systems, distributed databases, data lakes, network attached storage systems, streaming buffers, caching systems, and archival storage systems configured to store synchronized video, metadata, analytics outputs, reconstructed event models, player movement histories, biomechanical measurements, and generated replay sequences. The disclosed processing architecture improves the technical efficiency of distributed media processing systems by reducing redundant frame analysis, optimizing inference scheduling, compressing telemetry representations, and dynamically allocating computational resources according to real time processing demand.

In certain embodiments, the disclosed platform employs software frameworks and analytics engines configured to perform object recognition, player identification, skeletal pose estimation, equipment tracking, motion analysis, trajectory prediction, event classification, collision analysis, environmental modeling, tactical formation analysis, and probabilistic outcome forecasting. The software architecture may include operating systems, containerized processing frameworks, distributed orchestration systems, streaming engines, analytics pipelines, rendering engines, simulation engines, graphics frameworks, synchronization services, database management systems, media encoding systems, application programming interfaces, inference engines, event classification systems, and artificial intelligence model management systems.

The system may employ artificial intelligence models including convolutional neural networks, recurrent neural networks, transformer based neural networks, temporal convolutional networks, graph neural networks, graph attention networks, probabilistic inference models, Bayesian estimation systems, reinforcement learning systems, support vector machine classifiers, nearest neighbor classification systems, optical flow estimation models, semantic segmentation frameworks, feature extraction models, geometric projection models, depth estimation systems, simultaneous localization and mapping systems, volumetric reconstruction systems, spatial coordinate reconstruction systems, and multimodal inference architectures configured to process synchronized video and telemetry data streams.

In certain embodiments, the object recognition and tracking pipeline utilizes bounding box detection algorithms, semantic segmentation operations, feature point extraction, edge detection analysis, homography transformations, epipolar geometry calculations, triangulation methods, disparity mapping, temporal sequence analysis, Kalman filtering, particle filtering, probabilistic motion estimation, motion vector prediction systems, optical flow calculations, coordinate transformation matrices, and spatial interpolation frameworks to continuously calculate and analyze spatial coordinates, player acceleration, deceleration, direction changes, reaction times, body positioning, movement efficiency, ball trajectory, shot velocity, release angles, collision events, fatigue indicators, skeletal alignment, biomechanical asymmetries, and other gameplay metrics derived from synchronized multi camera imagery and sensor inputs.

The analytics framework may identify patterns, tendencies, strategic formations, player habits, offensive and defensive alignments, positioning inefficiencies, mechanical flaws, recovery characteristics, and other performance related indicators through continuous temporal analysis of movement data. The disclosed system may further detect anomalies or irregular motion patterns associated with potential injuries, fatigue accumulation, reduced mobility, concussion indicators, ligament stress patterns, abnormal gait mechanics, or elevated injury risk conditions using predictive biomechanical analysis models and probabilistic risk assessment systems.

In certain embodiments, the disclosed system generates two dimensional, three dimensional, or volumetric reconstructions of live gameplay environments suitable for replay analysis, tactical visualization, digital twin generation, mixed reality environments, augmented reality overlays, and avatar based simulations. The reconstruction engine may combine synchronized image streams from multiple cameras with depth estimation data, positional telemetry, and spatial coordinate calculations to generate a continuously updated spatial model of the live sporting environment.

In certain embodiments, players, officials, or sports equipment captured within the live video streams are converted in real time into animated avatars or photorealistic digital representations using artificial intelligence based reconstruction pipelines that perform depth estimation, neural field reconstruction, simultaneous localization and mapping, skeletal tracking, motion retargeting, facial feature mapping, mesh generation, volumetric interpolation, texture synthesis, and spatial coordinate reconstruction. The avatar generation subsystem may transmit compressed movement vectors, skeletal coordinate datasets, and reconstructed geometry representations in place of or alongside conventional video streams to reduce network bandwidth requirements while preserving motion fidelity and spatial accuracy. The reconstructed environments and avatar models may be synchronized with the original video streams using shared timing metadata to maintain temporal and spatial alignment across all playback, analytics, and replay systems.

The disclosed architecture may further include adaptive streaming and data management systems configured to dynamically optimize bandwidth utilization, encoding rate, frame rate, rendering resolution, network routing, and data transmission according to network conditions, device capability, processing load, latency measurements, and packet loss conditions. Artificial intelligence driven orchestration systems may allocate inference tasks across geographically distributed cloud computing clusters and edge processing nodes to support low latency analytics and large scale live event distribution. The orchestration layer may employ distributed inference engines, containerized processing architectures, federated learning systems, edge inference schedulers, predictive resource allocation models, distributed synchronization frameworks, adaptive caching systems, and automated load balancing systems to optimize processing efficiency and reduce latency.

The disclosed system thereby improves the technical operation of distributed video analytics and streaming infrastructures by enabling synchronized multi source event reconstruction, real time predictive analytics generation, adaptive volumetric rendering, automated replay generation, and dynamic network optimization using specialized computing architectures and artificial intelligence processing pipelines. The resulting platform enables scalable and synchronized live event capture, real time player and equipment analytics, automated highlight generation, predictive performance modeling, immersive broadcast rendering, officiating support, wagering analytics, scouting analysis, tactical simulation, injury detection analysis, and interactive viewer experiences suitable for professional, collegiate, amateur, and international sporting environments according to one embodiment.

### BRIEF DESCRIPTION OF THE DRAWINGS

FIG. 1A shows, for illustrative purposes only, an example of an overview of a football game multi-camera live-streaming method and devices of one embodiment.

FIG. 1B shows, for illustrative purposes only, an example of an overview of a baseball game multi-camera live-streaming method and devices of one embodiment.

FIG. 1C shows, for illustrative purposes only, an example of an overview of a basketball game multi-camera live-streaming method and devices of one embodiment.

FIG. 1D shows, for illustrative purposes only, an example of an overview of a soccer game multi-camera live-streaming method and devices of one embodiment.

FIG. 1E shows, for illustrative purposes only, an example of an overview of the multi-camera live-streaming method and devices being used to call balls and strikes and check swings during baseball game of one embodiment.

FIG. 2 shows a block diagram of an overview flow chart of one embodiment.

FIG. 3 shows, for illustrative purposes only, an example of training advertising mixed into the streaming of one embodiment.

FIG. 4 shows, for illustrative purposes only, an example of interactive advertising with touch screen purchasing of one embodiment.

FIG. 5 shows, for illustrative purposes only, an example of streaming advertiser ad revenue of one embodiment.

FIG. 6 shows, for illustrative purposes only, an example of multi-camera live-streaming processing of one embodiment.

FIG. 7A shows, for illustrative purposes only, an example of first camera, live-streaming auto action prioritizing of one embodiment.

FIG. 7B shows, for illustrative purposes only, an example of second camera live-streaming auto action prioritizing of one embodiment.

FIG. 8 shows, for illustrative purposes only, an example of ad mixing into streaming of one embodiment.

FIG. 9 shows, for illustrative purposes only, an example of record mode settings of one embodiment.

FIG. 10 shows, for illustrative purposes only, an example of highlights playback settings of one embodiment.

FIG. 11 shows, for illustrative purposes only, an example of split-screen mode selection of one embodiment.

FIG. 12A shows, for illustrative purposes only, an example of auto cross camera first view action targeting of one embodiment.

FIG. 12B shows, for illustrative purposes only, an example of auto cross camera second view action targeting of one embodiment.

FIG. 12C shows, for illustrative purposes only, an example of auto cross camera third-view action targeting of one embodiment.

FIG. 13A shows, for illustrative purposes only, an example of auto drone camera streaming tracking of one embodiment.

FIG. 13B shows, for illustrative purposes only, an example of auto fly baseball hit tracking of one embodiment.

FIG. 14 shows, for illustrative purposes only, an example of auto ad mixing timing of one embodiment.

FIG. 15 shows, for illustrative purposes only, an example of a cam user position selection of one embodiment.

FIG. 16A shows, for illustrative purposes only, an example of a school location GPS search of one embodiment.

FIG. 16B shows, for illustrative purposes only, an example of a school sports venue locator of one embodiment.

FIG. 17A shows, for illustrative purposes only, an example of a school football field sports venue identification of one embodiment.

FIG. 17B shows, for illustrative purposes only, an example of a sports venue N-S orientation of one embodiment.

FIG. 17C shows, for illustrative purposes only, an example of a football field sports venue recognition template of one embodiment.

FIG. 18A shows, for illustrative purposes only, an example of a school tennis sports venue locator of one embodiment.

FIG. 18B shows, for illustrative purposes only, an example of a tennis court sports venue recognition template of one embodiment.

FIG. 18C shows, for illustrative purposes only, an example of a school baseball sports venue locator of one embodiment.

FIG. 18D shows, for illustrative purposes only, an example of a baseball field sports venue recognition template of one embodiment.

FIG. 19 illustrates an adaptive streaming and data management system that dynamically optimizes bandwidth, resolution, and encoding for real-time broadcasts while supporting AI-driven avatar generation and mixed reality experiences.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

It should be noted that the descriptions that follow, for example, in terms of multi-camera live-streaming method and devices, are described for illustrative purposes, and the underlying system can apply to any number and multiple types of sporting events. In one embodiment of the present invention, the multi-camera live-streaming method and devices can be configured using an electronic application to record and access multi-camera sports video. The multi-camera live-streaming method and devices can be configured to include ground-level video cameras and can be configured to include drone-mounted video cameras to capture aerial footage using the present invention.

The term “multi-camera live-streaming method and devices” can be referred to herein as “ ” and/or “mobile application,” “mobile app,” “APP” without any change in meaning. The descriptions herein make reference to football as a game and piece of sports equipment, but any sport and corresponding piece of sports equipment can be substituted without changing any meanings or interpretations of the embodiments, with obvious context exceptions, for example, people pass a football but throw a baseball.

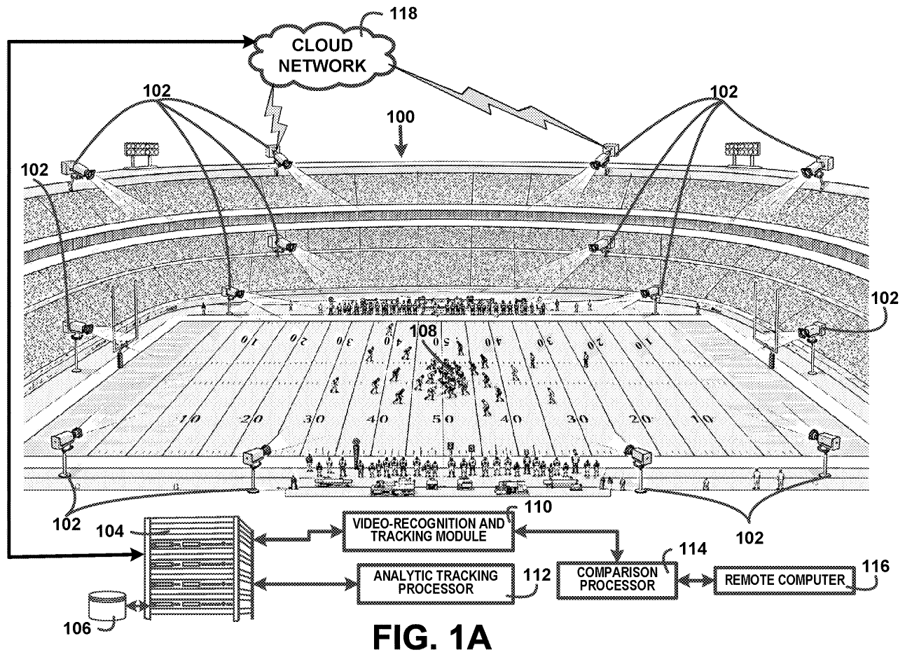

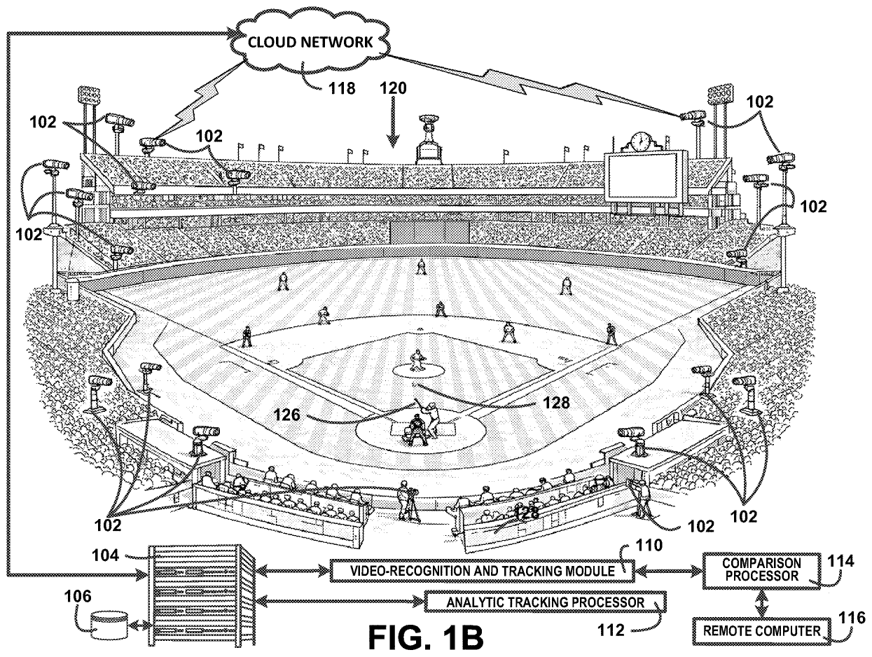

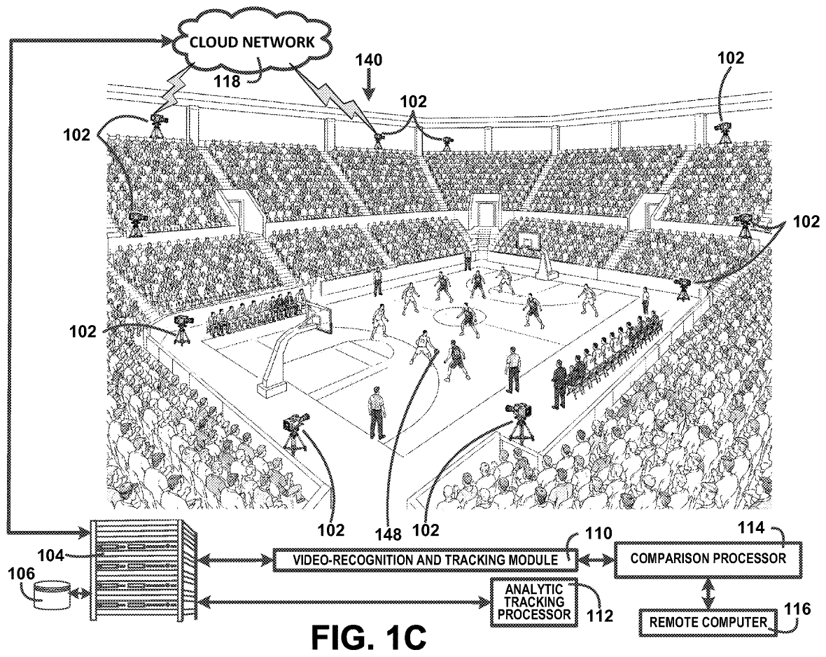

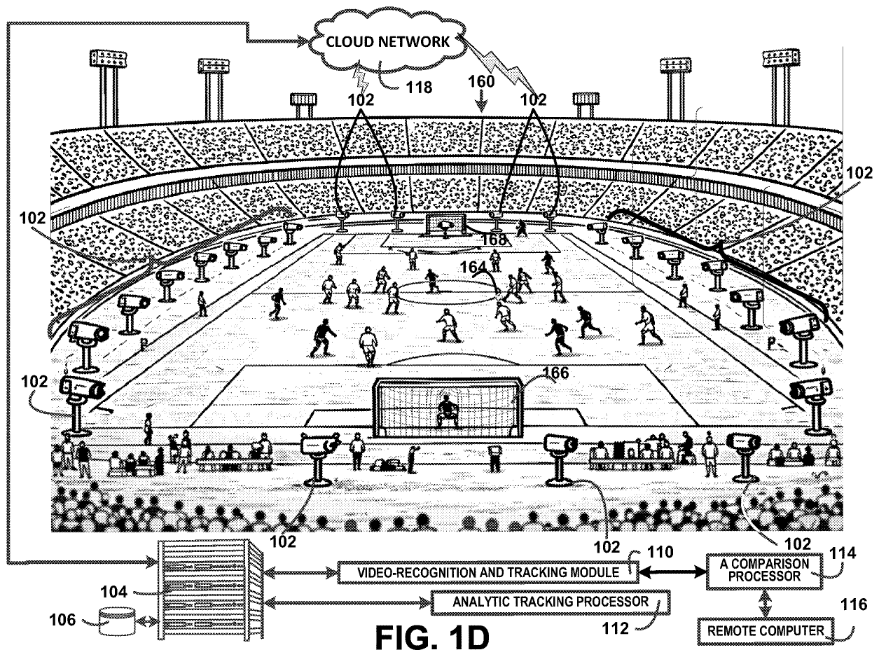

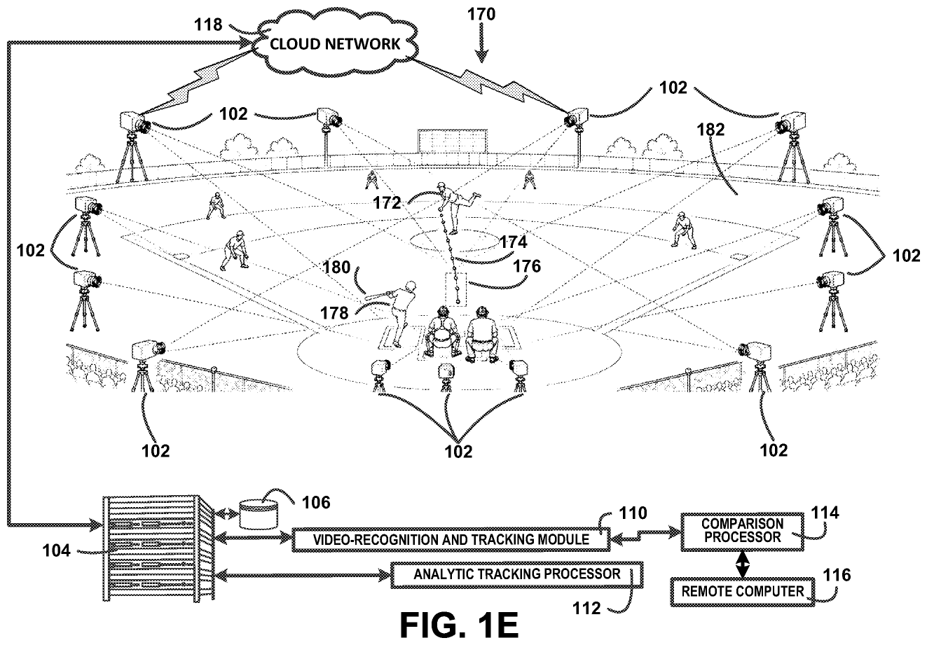

FIG. 1A illustrates, for example purposes only, an embodiment of a synchronized multi camera analytics and computer vision processing system configured for use during a live football sporting event 100. The football sporting event 100 occurs within a stadium environment including a playing surface, sidelines, seating structures, lighting systems, scoreboards, and broadcast infrastructure. A plurality of imaging devices 102 are positioned at distributed physical locations throughout the venue and oriented toward the playing field from different vantage points to capture overlapping live motion video streams of athletes, officials, and gameplay equipment.

The imaging devices 102 may include ultra high definition digital cameras, high frame rate optical cameras, stereoscopic cameras, depth sensing cameras, infrared cameras, thermal imaging devices, lidar systems, radar sensors, robotic pan tilt zoom cameras, aerial drone cameras, wearable cameras, mobile imaging devices, and machine vision sensors configured to capture synchronized visual and spatial data associated with gameplay activity. The imaging devices 102 may include complementary metal oxide semiconductor image sensors, charge coupled device image sensors, onboard graphics processors, embedded signal processors, optical stabilization systems, wireless communication modules, hardware video encoders, and onboard memory systems configured for real time image acquisition and transmission.

The plurality of imaging devices 102 capture multiple synchronized perspectives of the football sporting event 100, including sideline views, elevated stadium views, field level views, end zone perspectives, aerial perspectives, and dynamically controlled tracking views. The imaging devices 102 are configured to capture player formations, player acceleration, player spacing, blocking schemes, passing sequences, rushing attempts, tackling interactions, kicking operations, route development, and movement of gameplay equipment during football play sequences 108. The captured video streams and telemetry data are transmitted through one or more communication networks 118, which may include cellular communication systems, fiber optic networks, Wi Fi communication systems, mesh communication infrastructures, satellite communication systems, or edge computing networks, to one or more remote computer servers 104 or distributed cloud processing systems.

The remote computer server 104 receives continuous synchronized live motion video streams from the plurality of imaging devices 102 and generates frame aligned video datasets corresponding to the different camera viewpoints. In certain embodiments, the synchronization process utilizes network time protocol synchronization, precision time protocol synchronization, timestamp metadata, global positioning system timing references, frame synchronization pulses, or distributed clock alignment architectures configured to maintain sub frame synchronization accuracy between the captured video streams. The synchronized video datasets are stored within one or more databases 106, distributed storage systems, streaming buffers, or archival storage infrastructures for real time processing, replay analysis, historical comparison, machine learning training, and predictive analytics operations.

A video recognition and tracking module 110 analyzes the synchronized video streams to automatically identify, segment, classify, and track football players, officials, and gameplay equipment throughout the football sporting event 100. The video recognition and tracking module 110 may employ computer vision and artificial intelligence models including convolutional neural networks, recurrent neural networks, transformer based neural networks, graph neural networks, graph attention networks, semantic segmentation frameworks, optical flow estimation systems, feature extraction models, temporal sequence analysis systems, Bayesian estimation frameworks, reinforcement learning models, and probabilistic tracking architectures configured to process the synchronized video streams. In certain embodiments, the video recognition and tracking module 110 utilizes feature point extraction, edge detection analysis, homography transformations, epipolar geometry calculations, triangulation methods, disparity mapping, Kalman filtering, particle filtering, and spatial interpolation algorithms to determine player location, body orientation, velocity, acceleration, biomechanical posture, skeletal movement, and projected movement trajectories during gameplay.

An analytic tracking processor 112 calculates, in real time, projected paths, velocity vectors, rotational movement, travel distance, impact forces, release angles, and predicted trajectories associated with gameplay equipment during football actions including passing operations, punting operations, kicking operations, handoff sequences, fumble events, lateral movement, and player collisions. The analytic tracking processor 112 further determines player movement data including route direction, acceleration rates, deceleration rates, reaction times, spacing relationships between athletes, formation shifts, player separation metrics, defensive coverage characteristics, line movement behavior, and changes in field position during football play sequences 108. The analytic tracking processor 112 may further generate predictive gameplay models, tactical simulations, fatigue indicators, injury risk estimations, and probability based outcome forecasts using machine learning inference systems trained on historical gameplay datasets.

A comparison processor 114 compares the identified, segmented, and tracked gameplay data against previously stored datasets within the database 106 to determine quantifiable variations and performance differences between current athlete movement, gameplay equipment trajectory, historical player performance, historical team tendencies, biomechanical baselines, and previously recorded sporting events. The comparison processor 114 may identify movement inefficiencies, tactical tendencies, defensive patterns, offensive alignments, mechanical inconsistencies, recovery characteristics, abnormal motion signatures, and elevated injury probability indicators. In certain embodiments, the comparison processor 114 may further support officiating review, predictive analytics, wagering analytics, coaching analysis, scouting operations, player development analysis, and statistical performance modeling through continuous temporal comparison of synchronized gameplay datasets.

A remote computing device 116 operatively coupled to the remote computer server 104 is configured to display visual, graphical, statistical, and numerical representations of projected gameplay equipment trajectories, athlete movement data, and generated analytics. The remote computing device 116 may include workstations, mobile devices, tablets, augmented reality headsets, mixed reality devices, broadcast consoles, replay systems, or other network connected computing devices. The remote computing device 116 further displays reconstructed three dimensional graphical visualizations, volumetric replay environments, avatar based renderings, heat maps, spatial overlays, movement vectors, tactical simulations, and predictive gameplay models associated with the football sporting event 100.

In certain embodiments associated with the football sporting event 100 of FIG. 1A, the synchronized multi camera imaging devices 102, analytic tracking processor 112, and video recognition and tracking module 110 may further be configured to assist or automate officiating operations during gameplay. The disclosed system may analyze synchronized multi angle video streams and spatial tracking data to determine ball position relative to field markers, first down lines, goal lines, sidelines, hash marks, and end zone boundaries. The system may automatically determine whether a football crosses a goal line, whether a player steps out of bounds, whether forward progress has stopped, whether a catch has been completed, whether both feet remain in bounds during possession, whether a quarterback crosses the line of scrimmage, whether a ball carrier is down by contact, and whether a player commits pass interference, holding, offsides, false starts, illegal motion, facemask violations, helmet contact violations, delay of game violations, or roughing infractions. The disclosed system may further generate synchronized three dimensional reconstructions and trajectory models to assist with replay review operations, challenge reviews, clock management determinations, line to gain measurements, spot placement analysis, and player collision analysis. In certain embodiments, the system may automatically determine player contact timing, helmet impact location, and body positioning during collisions to assist with player safety review and officiating accuracy.

The system shown in FIG. 1A provides synchronized multi camera video acquisition, real time athlete and equipment tracking, projected trajectory analytics, biomechanical analysis, predictive modeling, distributed artificial intelligence processing, historical comparison operations, and three dimensional visualization of athletes and gameplay equipment during a live football sporting event according to one embodiment.

FIG. 1B illustrates, for example purposes only, an embodiment of a synchronized multi camera analytics and computer vision processing system configured for use during a live baseball sporting event 120. The baseball sporting event 120 occurs within a stadium environment including an infield region, outfield region, dugout structures, foul territory, bullpen areas, spectator seating, and broadcast infrastructure.

A plurality of imaging devices 102 are positioned throughout the venue at distributed physical locations and directed toward the baseball field from multiple synchronized viewpoints to capture continuous live motion video streams of athletes, officials, and gameplay equipment. The imaging devices 102 may include high speed optical cameras, stereoscopic cameras, depth sensing cameras, robotic tracking cameras, thermal imaging systems, lidar systems, radar systems, drone mounted cameras, machine vision systems, and other optical or electronic sensing devices configured to capture synchronized gameplay imagery and telemetry data.

The plurality of imaging devices 102 capture synchronized views of the baseball sporting event 120, including behind home plate perspectives, dugout level perspectives, baseline perspectives, outfield perspectives, overhead perspectives, and dynamically controlled tracking views. The imaging devices 102 are configured to capture pitching mechanics, batting mechanics, swing trajectories, fielding operations, base running sequences, throwing operations, player positioning, and movement of gameplay equipment during baseball play sequences including pitch delivery 126, bat to ball contact events, and projected ball trajectory movement 128. The captured video streams and telemetry information are transmitted through one or more communication networks 118 to one or more remote computer servers 104 or distributed cloud processing systems configured for synchronized real time analytics processing.

The remote computer server 104 receives continuous synchronized video streams from the plurality of imaging devices 102 and generates frame aligned video datasets corresponding to the different synchronized camera viewpoints. The synchronized datasets are stored within one or more databases 106 and distributed storage systems for real time analytics, historical comparison, replay generation, machine learning training, and predictive inference operations.

A video recognition and tracking module 110 analyzes the synchronized video streams to automatically identify, classify, segment, and track baseball players, officials, and gameplay equipment throughout the baseball sporting event 120. The video recognition and tracking module 110 may employ convolutional neural networks, transformer based neural networks, semantic segmentation models, optical flow analysis systems, depth estimation systems, temporal sequence analysis systems, and probabilistic tracking frameworks configured to process synchronized gameplay imagery and telemetry data. The tracking module determines player position, player orientation, skeletal movement, bat trajectory, pitch trajectory, rotational movement, release angle, velocity, acceleration, and projected equipment movement during gameplay operations.

An analytic tracking processor 112 calculates projected paths, rotational spin characteristics, projected travel distance, release dynamics, exit velocity, launch angle, biomechanical motion characteristics, and predicted trajectories associated with gameplay equipment during pitching, batting, throwing, and fielding operations. The analytic tracking processor 112 further determines player movement data including pitching mechanics, batting swing characteristics, stride efficiency, base running acceleration, fielding range, positional shifts, reaction time measurements, and biomechanical asymmetries during gameplay sequences. The analytic tracking processor 112 may further generate predictive outcome models, tactical simulations, fatigue indicators, injury risk assessments, and performance projections using artificial intelligence inference systems trained on historical gameplay datasets and biomechanical movement profiles.

A comparison processor 114 compares synchronized gameplay data against previously stored datasets within the database 106 to determine quantifiable variations and performance differences between current athlete mechanics, gameplay equipment trajectories, historical performance baselines, historical player tendencies, and previously recorded sporting events. The comparison processor 114 may identify tactical tendencies, mechanical inefficiencies, fatigue accumulation patterns, abnormal movement signatures, recovery characteristics, injury probability indicators, and statistical performance variations through continuous temporal analysis of synchronized gameplay data.

A remote computing device 116 operatively coupled to the remote computer server 104 displays visual, numerical, graphical, and analytical representations of gameplay equipment trajectories, athlete movement data, and predictive analytics associated with the baseball sporting event 120. The remote computing device 116 further displays reconstructed three dimensional gameplay environments, volumetric replay systems, avatar based simulations, movement heat maps, tactical overlays, biomechanical visualizations, and predictive gameplay models generated from synchronized gameplay data.

In certain embodiments associated with the baseball sporting event 120 of FIG. 1B, the synchronized imaging devices 102 and analytics systems may be configured to assist or automate umpiring and replay review operations. The disclosed system may determine the precise trajectory, velocity, rotational movement, and spatial coordinates of a pitched baseball relative to a dynamically generated strike zone model corresponding to a batter's body position and stance. The system may automatically determine the type of pitch based on spin and movement, whether a pitch is a strike or ball, whether a batter checked a swing, whether a baseball crossed foul lines, whether a runner was safe or out at a base, whether tag contact occurred prior to base contact, whether a catch occurred before a baseball contacted the ground, whether fan interference occurred, whether a baseball cleared a boundary fence for a home run, whether a runner left a base early, and whether obstruction or interference violations occurred. The synchronized multi camera system may further analyze bat trajectory, glove position, player foot placement, and baseball impact timing to support replay review and officiating determinations. In certain embodiments, the disclosed system may generate automated strike zone graphics, projected pitch trajectory models, swing path analysis, exit velocity calculations, launch angle calculations, and replay synchronized three dimensional visualizations to improve officiating accuracy and replay efficiency.

The system shown in FIG. 1B provides synchronized multi camera video acquisition, real time athlete and gameplay equipment tracking, projected trajectory analytics, biomechanical analysis, predictive performance modeling, distributed artificial intelligence processing, historical comparison operations, and three dimensional visualization of athletes and gameplay equipment during a live baseball sporting event according to one embodiment.

FIG. 1C illustrates, for example purposes only, an embodiment of a synchronized multi camera analytics and computer vision processing system configured for use during a live basketball sporting event 140. The basketball sporting event 140 occurs within an arena environment including a basketball court, boundary lines, baskets, spectator seating, lighting systems, scoreboards, and broadcast infrastructure. A plurality of imaging devices 102 are positioned at distributed locations throughout the arena and oriented toward the court from multiple synchronized viewpoints to capture continuous live motion video streams of athletes, officials, and a basketball during gameplay. The imaging devices 102 may include high frame rate optical cameras, ceiling mounted cameras, sideline cameras, baseline cameras, stereoscopic cameras, depth sensing cameras, infrared cameras, robotic pan tilt zoom cameras, wearable cameras, mobile imaging devices, lidar systems, radar sensors, inertial sensors, microphones, and other sensing devices configured to capture visual, spatial, positional, motion, and environmental data.

The plurality of imaging devices 102 capture synchronized views of the basketball sporting event 140, including baseline perspectives, sideline perspectives, overhead perspectives, elevated arena perspectives, and dynamically controlled tracking views. The imaging devices 102 are configured to capture player spacing, ball handling, dribbling sequences, passing actions, shot attempts 148, rebounding activity, defensive rotations, screens, cuts, switches, closeouts, transition movement, and other gameplay actions. The captured video streams and associated telemetry data are transmitted through one or more communication networks 118 to one or more remote computer servers 104 or distributed cloud processing systems configured for synchronized real time analytics processing.

The remote computer server 104 receives continuous synchronized video streams from the plurality of imaging devices 102 and generates frame aligned video datasets corresponding to the different camera viewpoints. The synchronized datasets are stored within one or more databases 106 for real time processing, historical comparison, replay generation, machine learning training, and predictive inference. A video recognition and tracking module 110 analyzes the synchronized video streams to automatically identify, segment, classify, and track basketball players, officials, and the basketball. The module may employ convolutional neural networks, recurrent neural networks, transformer based neural networks, temporal convolutional networks, graph neural networks, graph attention networks, semantic segmentation frameworks, pose estimation systems, optical flow estimation models, Bayesian estimation systems, Kalman filtering, particle filtering, homography transformations, triangulation methods, and spatial interpolation frameworks.

The video recognition and tracking module 110 determines the location, orientation, velocity, acceleration, movement trajectory, skeletal pose, body angle, jump height, landing mechanics, reaction time, player spacing, and relative positioning of each player and the basketball during the basketball sporting event 140. An analytic tracking processor 112 calculates, in real time, projected paths, shot arcs, release angles, ball velocity, pass velocity, dribble cadence, player acceleration, deceleration, lateral movement efficiency, defensive coverage distance, spacing efficiency, and probability based outcome metrics associated with gameplay actions. The analytic tracking processor 112 may further determine tendencies, including preferred shot locations, defensive weaknesses, offensive spacing patterns, fatigue indicators, injury risk indicators, matchup efficiencies, and tactical movement patterns.

A comparison processor 114 compares the identified, segmented, and tracked basketball data with previously stored data in the database 106 to determine quantifiable variations and differences between current player performance, basketball movement patterns, historical player baselines, team tendencies, biomechanical movement signatures, and prior recorded performance data. A remote computing device 116 operatively coupled to the remote computer server 104 displays visual and numerical representations of shot trajectories, passing paths, player movement vectors, spacing maps, heat maps, defensive coverage zones, predictive outcome models, and three dimensional graphical visualizations of the basketball players and basketball during the basketball sporting event 140.

In certain embodiments associated with the basketball sporting event 140 of FIG. 1C, the synchronized imaging devices 102 and analytics systems may be configured to assist or automate refereeing and replay review operations during gameplay. The disclosed system may automatically determine whether a player's foot contacts a sideline or baseline boundary, whether a player commits traveling, double dribbling, carrying, backcourt violations, shot clock violations, goaltending, basket interference, charging, blocking, or illegal contact fouls. The disclosed system may further determine whether a basketball leaves a player's hand before expiration of a game clock or shot clock, whether a player releases a shot before a buzzer event, whether a player remains within legal guarding position, and whether physical contact between players constitutes a foul based on player movement vectors, body positioning, and collision timing. In certain embodiments, the system may track player spacing, hand placement, ball trajectory, body orientation, and contact timing to generate replay synchronized officiating assistance data. The disclosed system may further provide automated replay review visualization, projected ball trajectory analysis, rim contact analysis, foot placement analysis, and synchronized three dimensional reconstructions of gameplay events to improve officiating consistency and reduce replay review time.

The system shown in FIG. 1C provides synchronized multi camera video acquisition, real time player and basketball tracking, shot and pass trajectory analytics, tactical formation analysis, injury risk evaluation, historical comparison, predictive performance modeling, and three dimensional visualization of athletes and gameplay equipment during a live basketball sporting event according to one embodiment.

FIG. 1D illustrates, for example purposes only, an embodiment of a synchronized multi camera analytics and computer vision processing system configured for use during a live soccer sporting event 160. The soccer sporting event 160 occurs within a stadium environment including a playing field, goal structures, boundary lines, midfield markings, penalty areas, spectator seating, lighting systems, scoreboards, and broadcast infrastructure. A plurality of imaging devices 102 are positioned at distributed physical locations throughout the stadium and oriented toward the field from multiple synchronized viewpoints to capture continuous live motion video streams of athletes, officials, and a soccer ball during gameplay. The imaging devices 102 may include sideline cameras, end line cameras, elevated stadium cameras, overhead cameras, robotic pan tilt zoom cameras, high frame rate optical cameras, stereoscopic cameras, depth sensing cameras, infrared cameras, thermal imaging devices, lidar systems, radar sensors, drone mounted cameras, wearable cameras, and other sensing devices configured to capture synchronized video, spatial data, positional data, motion data, and environmental data.

The plurality of imaging devices 102 capture synchronized views of the soccer sporting event 160, including sideline perspectives, end line perspectives, goal area perspectives, midfield perspectives, elevated stadium perspectives, aerial perspectives, and dynamically controlled tracking views. The imaging devices 102 are configured to capture player movement, ball possession, passing sequences, dribbling actions, defensive formations, pressing patterns, offensive advances, crosses, clearances, goalkeeper distributions, set pieces, shot attempts, ball movement across the field 164, goal area actions near a goal structure 166, and movement of the soccer ball toward the goal 168. The captured video streams and telemetry information are transmitted through one or more communication networks 118 to one or more remote computer servers 104 or distributed cloud processing systems configured for synchronized real time analytics processing.

The remote computer server 104 receives continuous synchronized video streams from the plurality of imaging devices 102 and generates frame aligned video datasets corresponding to the different synchronized camera viewpoints. The synchronized datasets are stored within one or more databases 106 for real time analytics, historical comparison, replay generation, machine learning training, and predictive inference operations. A video recognition and tracking module 110 analyzes the synchronized video streams to automatically identify, classify, segment, and track soccer players, officials, and the soccer ball throughout the soccer sporting event 160. The module may employ convolutional neural networks, recurrent neural networks, transformer based neural networks, temporal convolutional networks, graph neural networks, graph attention networks, semantic segmentation systems, optical flow analysis, homography transformations, triangulation, Kalman filtering, particle filtering, probabilistic tracking, and spatial interpolation.

The video recognition and tracking module 110 determines player location, player orientation, sprint speed, acceleration, deceleration, distance covered, spacing, formation position, passing lanes, ball location, ball velocity, ball trajectory, and movement patterns during gameplay. An analytic tracking processor 112 calculates, in real time, projected paths, speed, travel distance, passing probabilities, shooting probabilities, defensive coverage metrics, player workload, pressing intensity, formation compactness, off ball movement, transition speed, and coordinated team movement. The analytic tracking processor 112 may further generate tactical tendency analysis, scouting reports, fatigue indicators, injury risk metrics, player development assessments, and probability based event forecasts.

A comparison processor 114 compares the identified, segmented, and tracked soccer data with previously stored data in the database 106 to determine quantifiable variations and differences between current player performance, ball movement patterns, historical player baselines, team strategies, positional tendencies, biomechanical movement signatures, and prior recorded performance data. A remote computing device 116 operatively coupled to the remote computer server 104 displays visual and numerical representations of projected ball paths, passing networks, player movement vectors, heat maps, formation maps, expected event models, tactical overlays, and three dimensional graphical visualizations of the soccer players and soccer ball during the soccer sporting event 160.

In certain embodiments associated with the soccer sporting event 160 of FIG. 1D, the synchronized imaging devices 102 and analytics systems may be configured to assist or automate officiating and replay review operations during gameplay. The disclosed system may automatically determine whether a soccer ball completely crosses a goal line, whether a player is positioned offside relative to defenders and ball position, whether a player commits handball violations, whether fouls occur during tackling or physical contact, whether a ball exits field boundaries, whether a goalkeeper illegally handles a ball, and whether penalty area violations occur. The disclosed system may further analyze player spacing, body positioning, ball trajectory, contact timing, and collision dynamics to determine whether advantage conditions exist, whether simulation or embellishment occurs, and whether misconduct violations are committed. In certain embodiments, the system may generate synchronized replay visualizations, projected ball trajectories, offside line projections, player movement overlays, goal line analysis, and three dimensional reconstructions of gameplay events to improve officiating accuracy and replay analysis. The disclosed system may further support automated timing synchronization between game clocks, stoppage calculations, and event review systems.

The system shown in FIG. 1D provides synchronized multi camera video acquisition, real time player and soccer ball tracking, projected ball path analytics, tactical formation analysis, scouting analytics, injury risk analysis, historical comparison, predictive performance modeling, and three dimensional visualization of athletes and gameplay equipment during a live soccer sporting event according to one embodiment.

In certain embodiments, the disclosed synchronized multi camera officiating and replay review systems of FIGS. 1A, 1B, 1C and 1D, may operate in a fully automated mode without direct human intervention or may operate in an assisted officiating mode in which replay officials, referees, umpires, judges, league officials, broadcasters, coaches, or event administrators review analytics generated by the system prior to final determination of gameplay rulings. The disclosed systems may further utilize probabilistic confidence scoring, anomaly detection systems, predictive trajectory modeling, and consensus based inference frameworks to determine confidence levels associated with generated officiating decisions. The synchronized multi camera replay and officiating architecture thereby improves officiating consistency, replay review efficiency, event synchronization accuracy, player safety analysis, and gameplay analytics generation according to one embodiment.

In certain embodiments associated with the baseball sporting event 170 of FIG. 1D, the synchronized imaging devices 102 and analytics systems may be configured to assist or automate officiating and replay review operations during gameplay. The disclosed system may automatically determine whether a baseball completely crosses a goal line, whether a player is positioned offside relative to defenders and baseball position, whether a pitcher 172 commits a balk violations, whether a baseball exits foul boundaries, and whether a catcher illegally handles a baseball. The disclosed system may further analyze player spacing, body positioning, baseball trajectory, contact timing, and collision dynamics to determine whether advantage conditions exist, whether simulation or embellishment occurs, and whether misconduct violations are committed. In certain embodiments, the system may generate synchronized replay visualizations, projected baseball trajectories, offside line projections, player movement overlaandys, goal line analysis, and three dimensional reconstructions of gameplay events to improve officiating accuracy and replay analysis. The disclosed system may further support automated timing synchronization between game clocks, stoppage calculations, and event review systems.

The system shown in FIG. 1D provides synchronized multi camera video acquisition, real time player and baseball tracking, projected baseball path analytics, tactical formation analysis, scouting analytics, injury risk analysis, historical comparison, predictive performance modeling, and three dimensional visualization of athletes and gameplay equipment during a live baseball sporting event according to one embodiment.

FIG. 1E shows, for illustrative purposes only, an example of an overview of a baseball game multi-camera live-streaming method and devices of one embodiment. FIG. 1E illustrates, for example purposes only, an embodiment of a synchronized multi-camera analytics and computer vision processing system configured for use during a live baseball sporting event 170. The baseball sporting event 170 occurs within a baseball park environment including a playing field, batter's box, catcher's box, pitcher's mound, first base, second base, third base, home plate, foul lines, spectator seating, lighting systems, officiating systems, and broadcast infrastructure. A plurality of imaging devices 102 are positioned at distributed physical locations throughout the stadium and oriented toward the field from multiple synchronized viewpoints to capture continuous live-motion video streams of athletes, officials, a bat 180, and a baseball 174 during gameplay activity.

The imaging devices 102 may include field level cameras, elevated stadium cameras, overhead cameras, robotic pan tilt zoom cameras, high frame rate optical cameras, depth sensing cameras, infrared cameras, thermal imaging devices, lidar systems, radar sensors, drone mounted cameras, wearable cameras, and other sensing devices configured to capture synchronized video, audio, spatial data, positional data, motion data, telemetry information, and environmental data associated with the baseball sporting event 170. The plurality of imaging devices 102 may collectively provide overlapping visual coverage of gameplay activity occurring within one or more predefined gameplay regions 176 associated with the baseball sporting event 170 to enable synchronized multi-view gameplay analysis, replay generation, gameplay event confirmation, officiating assistance processing, and automated or semi-automated determination of gameplay events associated with balls, strikes, check swings, swing attempts, batter movement, bat movement, and other gameplay events governed by one or more sporting event mandated rules of play.

The plurality of imaging devices 102 are configured to capture synchronized live-motion video streams associated with player movement, pitching actions, batting actions, catcher positioning, throwing actions, fielding actions, running actions, gameplay interactions, umpire activity, and movement of the baseball 174 throughout gameplay activity. The synchronized video streams may capture movement of the baseball 174 after release from a pitcher, projected movement paths of the baseball 174 toward the strike zone 176 or other predefined gameplay regions associated with the baseball sporting event 170, movement of the baseball 174 relative to a batter 178 and a catcher, and interaction timing associated with gameplay events occurring during the baseball sporting event 170. The synchronized video streams may further capture movement of the baseball 174 before, during, and after interaction with players, sporting equipment, predefined gameplay regions, or gameplay boundary locations associated with calling or confirming balls, strikes, swing attempts, check swings, foul tips, and other gameplay determinations associated with the sporting event mandated rules of play.

The synchronized video streams generated by the plurality of imaging devices 102 may further capture movement associated with the batter 178 and the bat 180 during gameplay activity. The captured movement data may include bat orientation, bat trajectory, bat positioning, bat acceleration, bat movement timing, player body positioning, player skeletal positioning, arm movement, wrist movement, torso rotation, lower body positioning, coordinated body movement sequences, and spatial relationships between the bat 180 and the baseball 174 during gameplay activity. The synchronized video streams may further capture partial swing sequences, interrupted swing sequences, attempted swing actions, follow-through movement, interaction timing associated with movement of the bat 180 relative to the baseball 174, and gameplay movement associated with determining whether a detected gameplay activity constitutes a swing attempt, a check swing, a completed swing, or another gameplay activity associated with the sporting event mandated rules of play.

The captured video streams and telemetry information are transmitted through one or more communication networks 118 to one or more remote computer servers 104 or distributed cloud processing systems configured for synchronized real time analytics processing, gameplay analysis, predictive analytics processing, gameplay event evaluation, replay generation, officiating assistance processing, and automated gameplay determination processing. The remote computer server 104 may generate synchronized video datasets corresponding to different camera viewpoints and may temporally associate corresponding image frames from the plurality of imaging devices 102 to enable synchronized multi-view gameplay analysis associated with the baseball 174, the batter 178, the bat 180, participating players, and the strike zone 176 or other predefined gameplay regions associated with the baseball sporting event 170. The synchronized datasets may be stored within one or more databases 106 for gameplay analysis, replay generation, predictive analytics processing, historical comparison operations, machine learning operations, artificial intelligence training operations, gameplay event classification processing, gameplay officiating analysis, and graphical replay generation.

A video recognition and tracking module 110 executed by the remote computer server 104 may analyze the synchronized video streams to automatically identify, classify, segment, and track participating players, officials, the baseball 174, and the bat 180 during the baseball sporting event 170. The video recognition and tracking module 110 may determine player location, player orientation, baseball location, baseball velocity, baseball trajectory, bat trajectory, bat orientation, bat movement timing, and movement relationships between the baseball 174, the bat 180, and participating players during gameplay activity. An analytics processor 112 may further determine projected movement paths, projected travel distances, spatial locations, interaction locations, and movement trajectory data associated with the baseball 174 and the bat 180 relative to the strike zone 176 or one or more predefined gameplay regions associated with the baseball sporting event 170. The analytics processor 112 may further determine whether detected gameplay movement associated with the baseball 174, the bat 180, or participating players satisfies one or more gameplay activity conditions associated with calling or confirming balls, strikes, check swings, attempted swings, or other gameplay determinations governed by the sporting event mandated rules of play.

A comparison processor 114 may compare synchronized gameplay data generated from the synchronized video streams with previously stored gameplay datasets within the database 106 to determine quantifiable variations and differences between current gameplay activity and previously recorded gameplay activity. The comparison processor 114 may further analyze historical gameplay movement patterns, historical player movement data, historical baseball trajectory data, historical bat movement data, and previously recorded gameplay event sequences to generate predictive gameplay analytics, gameplay event classifications, projected gameplay outcomes, replay analytics, graphical overlays, and three-dimensional graphical visualizations associated with the baseball sporting event 170. A remote computing device 116 operatively coupled to the remote computer server 104 may display synchronized replay data, projected movement paths, gameplay analytics, gameplay event evaluations, officiating assistance data, and graphical visualizations associated with the baseball 174, the bat 180, participating players, and the strike zone 176 or other predefined gameplay regions during or after the baseball sporting event 170.

In certain embodiments, the disclosed synchronized multi camera officiating and replay review systems of FIG. 1A, FIG. 1B, FIG. 1C, FIG. 1D and FIG. 1E, may operate in a fully automated mode without direct human intervention or may operate in an assisted officiating mode in which replay officials, referees, umpires, judges, league officials, broadcasters, coaches, or event administrators review analytics generated by the system prior to final determination of gameplay rulings. The disclosed systems may further utilize probabilistic confidence scoring, anomaly detection systems, predictive trajectory modeling, and consensus based inference frameworks to determine confidence levels associated with generated officiating decisions. The synchronized multi camera replay and officiating architecture thereby improves officiating consistency, replay review efficiency, event synchronization accuracy, player safety analysis, and gameplay analytics generation according to one embodiment.

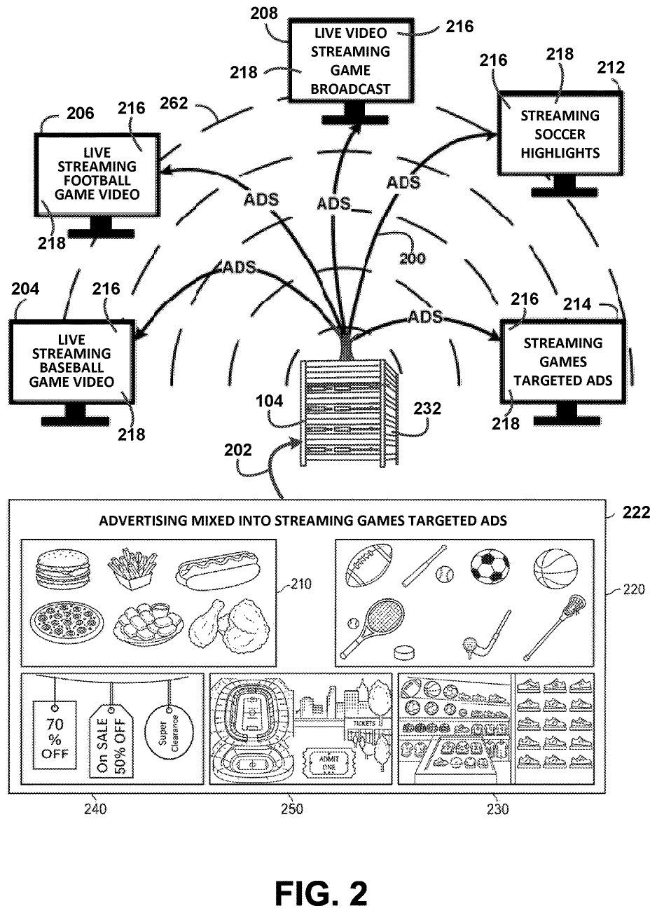

FIG. 2 shows, for illustrative purposes only, an example of an overview flow chart of a multi-camera live-streaming method and devices, according to one embodiment. A plurality of video camera imaging devices 102 capture live-motion video of a sporting event and transmit the captured video data to a remote computer server 104 through a communication network.

The remote computer server 104 receives the video data streams from the plurality of video camera imaging devices 102 and processes the video data streams to generate synchronized live video streams. The remote computer server 104 transmits the synchronized live video streams internet signals 262 through an internet signal transmitter 232 to a plurality of subscriber's digital devices 218.

Each subscriber's digital device 218 executes an application 216 configured to receive and display the synchronized live video streams of the sporting event. The application 216 provides user-selectable viewing modes including live streaming, recording, full reel playback, and highlights playback.

The remote computer server 104 further processes the video data streams to generate highlight segments and stores the highlight segments in one or more databases for retrieval and playback. The remote computer server 104 dynamically manages transmission, synchronization, and storage of the video data streams to provide continuous live streaming and playback functionality.

The remote computer server 104 generates live streaming baseball game video 204 to a subscriber's display device 218 having a streaming video application 216. From other cameras at another sporting event are generated live streaming football game video 206 with a live video streaming game broadcast 208. Streaming soccer highlights 212 also include streaming games targeted ads 214. The advertising mixed into streaming games targeted ads 222 are displayed as streaming video transmitted through remote computer server 202. Subscriber'ss make, targeted ads food orders on line 210, purchase sports equipment ads order online 220, view targeted ads for sports clothing and equipment 230, discount offered on targeted ads 240, and purchase targeted ads sporting events tickets 250.

Thus, the system shown in FIG. 2 provides a coordinated multi-camera live-streaming architecture including video capture, transmission, synchronization, processing, storage, and playback across a plurality of subscriber's digital devices 218.

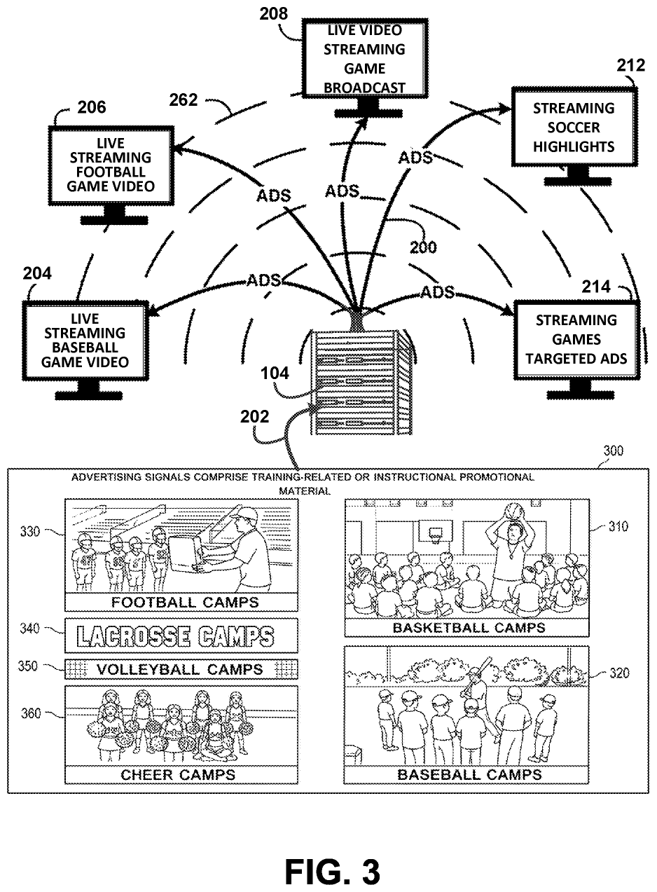

FIG. 3 shows, for illustrative purposes only, an example of training advertising mixed into streaming, according to one embodiment. A plurality of video camera imaging devices 102 transmit live-motion video streams of a sporting event to a remote computer server 104. The remote computer server 104 processes the video streams and transmits a synchronized network remote computer server 104 internet signals 262 through an internet signal transmitter 232.

The network remote computer server 104 internet signal is received by a plurality of subscriber's digital devices 218 executing an application, which displays a live video-streaming game broadcast 208. The remote computer server 104 includes an ad-insertion module configured to insert advertising signals 200 into the live video-streaming game broadcast 208 in real time.

The remote computer server 104 generates live streaming baseball game video 204 to a subscriber's display device 218 having a streaming video application 216. From other cameras at another sporting event are generated live streaming football game video 206 with a live video streaming game broadcast 208. Streaming soccer highlights 212 also include streaming games targeted ads 214.

The advertising mixed into streaming games targeted ads 222 are displayed as streaming video transmitted through remote computer server 202. Subscriber'ss make, targeted ads food orders on line 210, purchase sports equipment ads order online 220, view targeted ads for sports clothing and equipment 230, discount offered on targeted ads 240, and purchase targeted ads sporting events tickets 250.

In one embodiment, the advertising signals 200 include training-related or instructional promotional content 300 directed to athletes, parents, and coaches. The training-related promotional content 300 includes advertisements for sports training programs, including basketball camps 310, baseball camps 320, football camps 330, lacrosse camps 340, volleyball camps 350, and cheerleading camps 360.

The remote computer server 104 selects and inserts the advertising signals 200 into the live video-streaming game broadcast 208 based on contextual data associated with the sporting event or the subscriber's digital devices 218. The advertising signals 200 are transmitted with minimal latency and are synchronized with the video streams to maintain continuity of the live video-streaming game broadcast 208.

The remote computer server 104 records engagement data associated with the advertising signals 200 and stores the engagement data in a database for later analysis and reporting.

Thus, the system shown in FIG. 3 provides real-time insertion of training-related advertising into live video streaming game broadcast 208 with synchronized delivery to a plurality of subscriber's digital devices 218 and transaction processing while maintaining continuous display of the live video-streaming

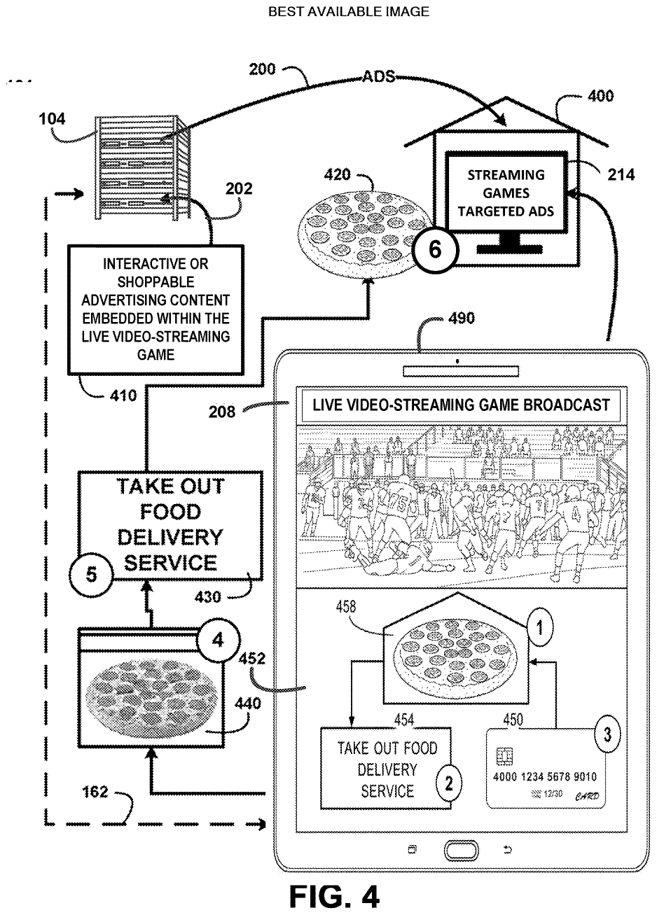

FIG. 4 shows for illustrative purposes only an example of interactive advertising with touch screen purchasing of one embodiment. FIG. 4 shows the internet signal transmitter 232 transmitting advertising signals 200 from the remote computer server 104. The network server internet signal 262 is transmitted to the subscriber's digital device 218 with application 216 installed, for example a tablet 490 with the application 216. The advertising signals 200 from the remote computer server 104 include interactive advertising with touch screen purchasing programmed into live video streaming games 410 using the application 216. FIG. 4 shows the live video streaming game broadcast 208 on a subscriber digital device with application installed for example a tablet 490 with the application 216.

The internet signal 262 transmits the live video streaming game broadcast 208 including an application 216 interactive retail online ordering feature 452. During the live video streaming game the ordering process includes Step 1 a subscribed viewer selected retail ad displayed on tablet 458 is in this example a pizzeria. The subscribed viewer places an online order. Step 2 the subscribed viewer selects take-out food delivery service 454. Step 3 the subscribed viewer pays for the order with a bank card 450. The selected take-out food delivery service performs step 4 order picked up at retailer 440. Step 5 the order being delivered by take-out food delivery service 430.

Step 6 the subscribed viewer food order delivered 420 to the subscribed viewer home 400. The subscribed viewer can continue to view the live video streaming game broadcast 208 using the split screen feature of the application 216 of one embodiment.

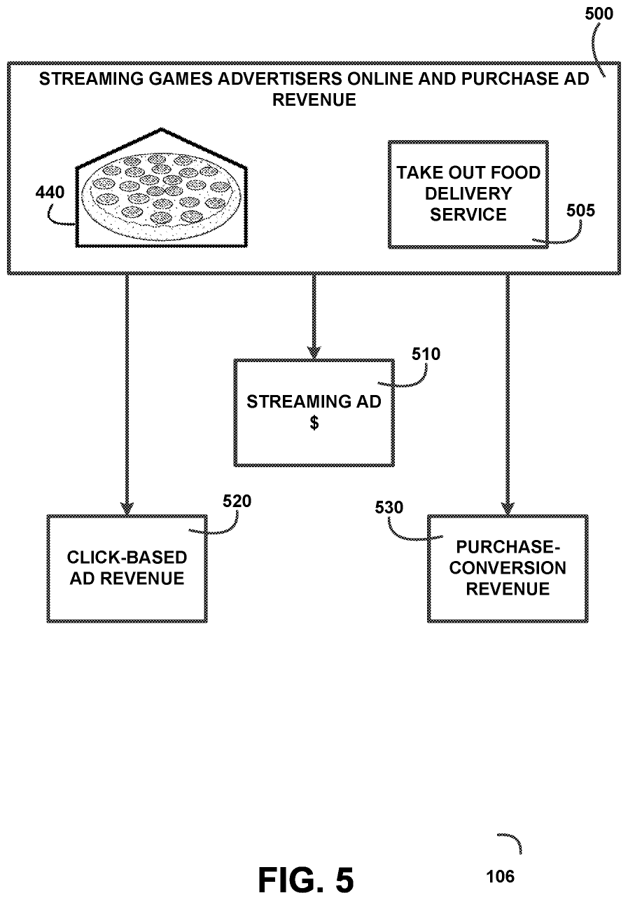

FIG. 5 shows, for illustrative purposes only, an example of advertiser-generated revenue derived from live video streaming game broadcast 208, according to one embodiment. A remote computer server 104 of FIG. 1 transmits advertising mixed into streaming games targeted ads 222 of FIG. 2. A remote computer server 104 of FIG. 1 transmits a live video streaming game broadcast 208 of FIG. 2 that includes advertising signals 200 of FIG. 2 to a plurality of subscriber's digital devices 218 of FIG. 2 executing an application 216 of FIG. 2.

The advertising signals 200 of FIG. 2 include advertisements associated with one or more advertisers, including at least one sports clothing and equipment retailer 440 of FIG. 4 and at least one take out food delivery service 505. The advertising signals 200 generate advertising revenue through multiple engagement levels, including streaming advertisement revenue 510, click-based advertisement revenue 520, and purchase-conversion revenue 530.

The remote computer server 104 of FIG. 1 receives the total of the streaming games advertisers online and purchase ad revenue 500 generated from the advertising signals 200 of FIG. 2 and allocates a portion of the total of the streaming games advertisers online and purchase ad revenue 500 as a donation to one or more participating organizations, including schools associated with the live video-streaming game broadcast 208 of FIG. 2. The schools receiving the donation allocate the received funds to support athletic programs, including purchasing equipment, funding operations, and covering transportation expenses for athletic events.

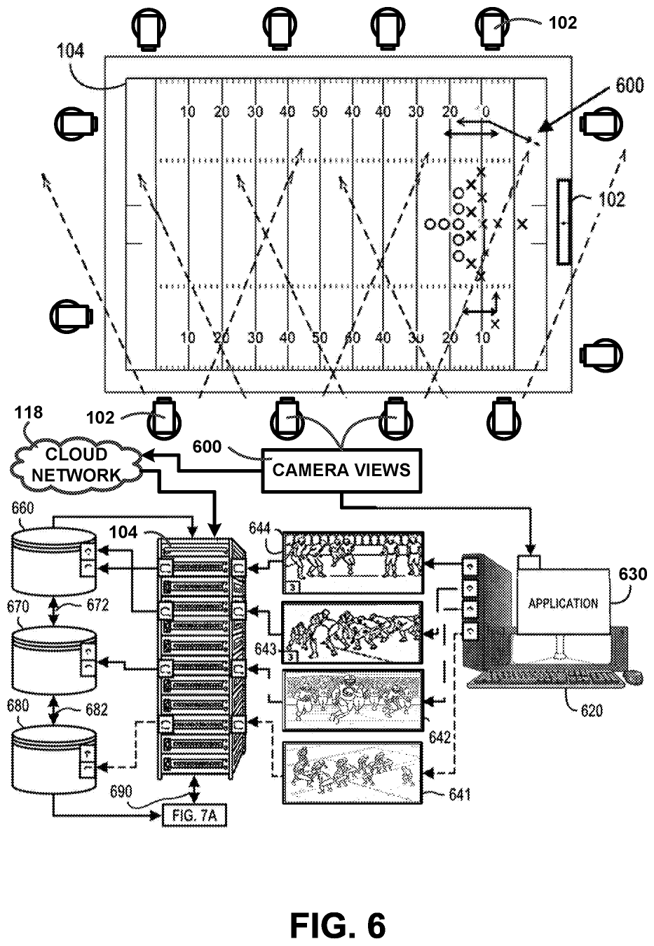

FIG. 6 shows for illustrative purposes only an example of multi-camera live-streaming processing of one embodiment. FIG. 6 shows a sports venue for example a high school football field 104 including the scoreboard 102. Showing in FIG. 6 are two teams on the field shown in playbook format for illustration ease 600. Also shown are the camera #1 with app installed 100 video camera #1 view 610, camera #2 with app installed 110 video camera #2 view 611, camera #3 with app installed 120 video camera #3 view 612, and camera #4 with app installed 130 video camera #4 view 613. A cellular transmission from each camera is received by a network computer 620 coupled to a remote computer server 104.

A network computer 620 coupled to a remote computer server 104 is used for example in a process where a video camera #1 view is processed in a server digital processor 642 to detect motion on the field and target the football in this example to identify probable action for auto highlight selections of the game 641. Also video camera #2 views are processed in a server digital processor 642, video camera #3 views is processed in a server digital processor 643, and video camera #4 views is processed in a server digital processor 644 using an electronically overlaid coordinate grid to detect motion. A remote computer server 104 for example where video camera #1 auto highlight selections are recorded in a first auto highlights database 680.

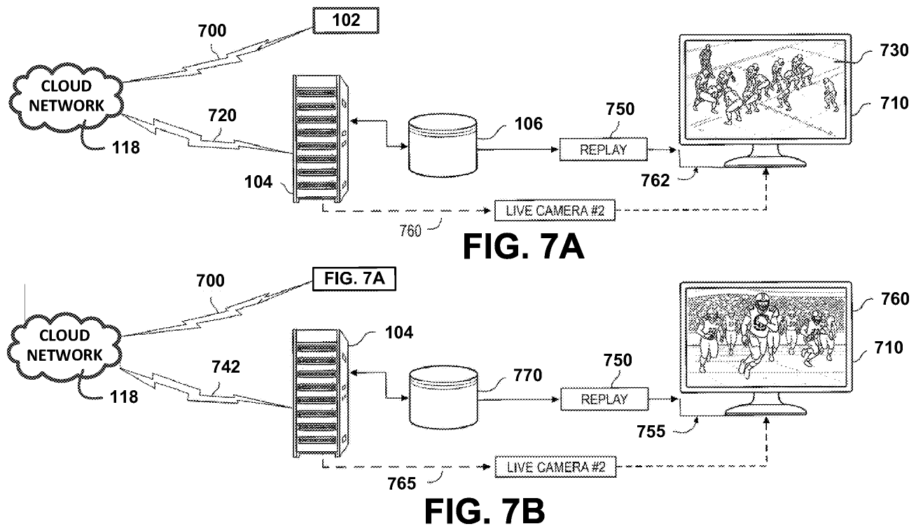

During an auto highlight selection capture the entire footage of video camera #1 is simultaneously being recorded in a full reel database 660. Video camera #2 auto highlight selections are recorded in a second auto highlights database 670 and during an auto highlight selection capture the entire footage of video camera #2 is simultaneously being recorded in a full reel database 660. No motion is detected in one camera views and video camera captured footage is recorded in a full reel database 660. The full reel database 660 entire footage from all cameras can be retrieved for playbacks. Auto highlight selections are chronologically matched into a single reel during the game from all cameras and recorded in a game highlights section of the full reel database 660. Footage recorded is tagged with the ID # of the home team and visitor team, date and other data for ease of queries on playbacks of one embodiment. Additional processing 690 is described in FIG. 7A.

FIG. 7A shows for illustrative purposes only an example of first camera live-streaming auto action prioritizing of one embodiment. A continuation from FIG. 6 includes FIG. 7A shows the cellular tower 150 receiving the live streaming video feed from the app cameras. The internet signal transmitter 232 of the remote computer server 104 is broadcasting the live streaming feed from live camera #2 760.

The game action has stopped for example for an end of play or a time-out called. The subscriber has selected a camera #1 auto highlight selection replay 750. The subscriber replay 750 selection is processed 700. The camera #1 highlight replay 750 can be shown 730 to a subscribed viewer to watch in-between plays on a subscribed viewer digital device 710. The live camera #2 760 broadcast will continue in the background 762 while the replay 750 is showing. The highlighted replay 750 will play for a limited time until play resumes and live video streaming game will resume of one embodiment.

FIG. 7B shows for illustrative purposes only an example of second camera live-streaming auto action prioritizing of one embodiment. FIG. 7B shows the cellular tower 150 receiving the live streaming video feed from the app cameras. The remote computer server 104 has determined that play is about to resume based on the formation of lining up along the scrimmage line of the players has begun. The internet signal transmitter 232 of the remote computer server 104 continues broadcasting the live video streaming feed from camera #2 765 and the broadcast of the camera #1 highlight replay 750 is interrupted 755 and the live camera #2 broadcast is displayed 760 on the subscribed viewer digital device 710. The camera #1 auto highlight selection replay 750 can be requested by a subscribed viewer to watch in-between plays at any time of one embodiment.

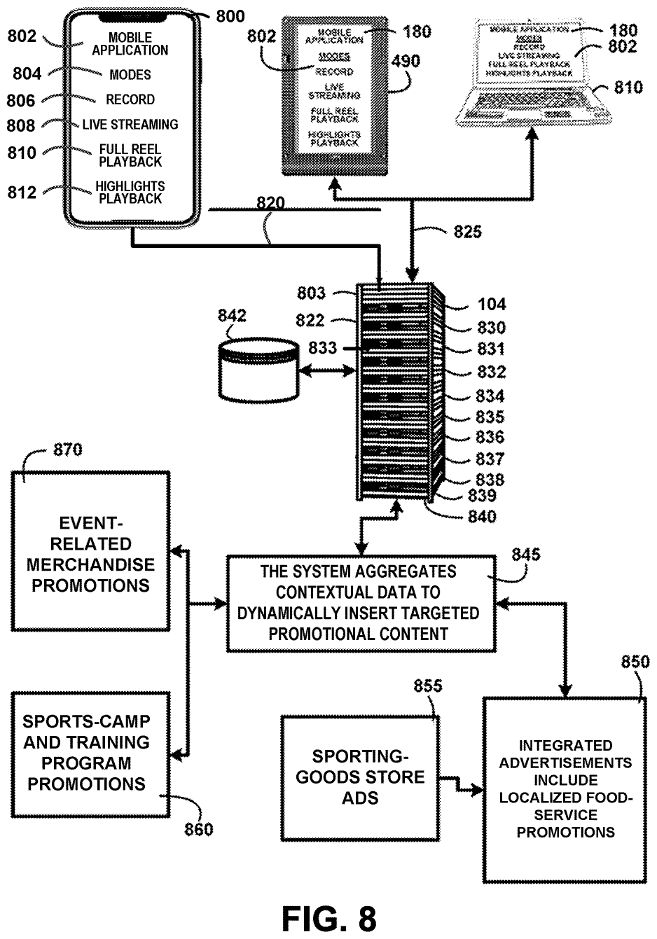

FIG. 8 shows for illustrative purposes only an example of ad mixing into streaming of one embodiment. FIG. 8 shows subscribed viewer digital devices including a smart phone 800, the tablet 490, a computer and a laptop computer 810 with the mobile application 216 installed. The mobile application 216 displays a modes selection menu 802 including record, live-streaming, full reel playback and highlights playback. The modes selection menu 802 is displayed on a home page from a website 803 on the remote computer server 104.

The mobile application 216 connects to the remote computer server 104. The remote computer server 104 is coupled to at least one digital database 830, at least one digital processor 831, at least one OCR device 832, at least one WI-FI connectable device 833, at least one printer 834, at least one video device 835, at least one cellular connectable device 836, at least one data mining device 837, at least one internet connectable device 838, at least one internet signal transmitter 232, at least one OCR device 839, at least one digital memory device 840, at least one advertising database 842, and a sports equipment recognition tracking device 822.

The sports equipment recognition tracking device 822 includes a database of various sports equipment for example a football, baseball, tennis ball, hockey puck, baseball bat, hockey stick, tennis racquet and other pieces of sports equipment including the standard dimensions and shapes and colors. The sports equipment recognition tracking device 822 scans the video images being captured to match images of a database example of a particular piece of sports equipment and then tracks it movement on the video captured images.

Advertising mixed into streaming games targeted ads to youth athletes and their parents 845 includes a process for internet data mining of contracted local advertisers including food service and sporting goods stores 850, contracted local advertisers sales and discount opportunities 855, contracted sports training and camps promotional ads 860, and contracted professional and collegiate sports merchandise promotional ads 870 of one embodiment.

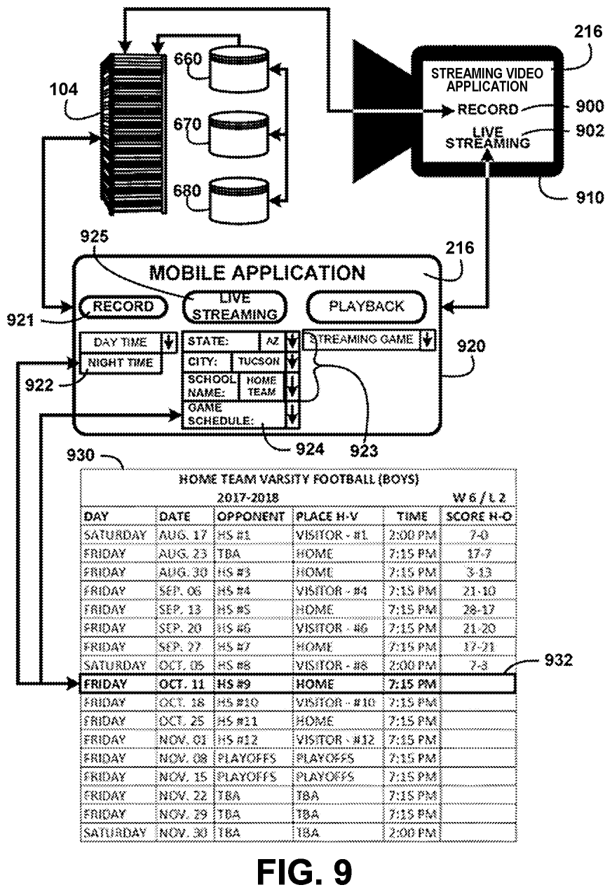

FIG. 9 shows for illustrative purposes only an example of record mode settings of one embodiment. FIG. 9 shows the mobile application 216 modes including record, live-streaming, full reel playback and highlights playback are displayed on a home page from a website 803 on the remote computer server 104. The subscribed viewer can select a record mode 900 and live-streaming mode 902 on a video camera with a app 180 installed and cellular connectivity 910. Selecting the record mode 900 and live-streaming mode 902 is the same process for all video camera imaging devices 102.

Each video camera with the record mode selected is connected to the remote computer server 104. Video camera 102 recordings of captured footage are recorded in a full reel database 660, video camera auto highlight selections are recorded in a second auto highlights database 670, and video camera auto highlight selections are recorded in a first auto highlights database 680. A mobile application mode selection menu 920 includes a selection to record 921 where for example a state drop down where AZ has been selected 923, a city drop down where Tucson has been selected and a school name drop down where ‘home team” has been selected by the subscribed viewer. An ambient light drop down where night time has been automatically selected based on the time of the game 7:15.mu.m 922.

A game schedule drop down 924 appears on screen from one of the at least databases where data mining of the names of high schools in Tucson, Ariz, and their game schedules have been recorded. The mobile application 216 shows the home team season game schedule that was gathered from a data mining device process and OCR processed to create digitally readable data 930. A camera operator selects the game to be live streamed from the game schedule 932. At least one digital processor 831 has entered the scores from the previous games and calculated the win loss totals showing as W6/L2. The OCR device converts an image captured of a final game scoreboard data into readable text which includes the home and visitor scores for recording and processing on the remote computer server 104.

The mobile application 216 turns a subscribed viewer handheld device into a live switching TV studio for multi-cam coverage of any event. The mobile application 216 brings multi-camera programming of live sports to the handheld devices many people own. The mobile application 216 allows multiple devices to record and control a subscribed viewer device to switch video feeds for live broadcasting and the recorded live broadcast feed can be watched later on any device with the mobile application 216 of one embodiment.

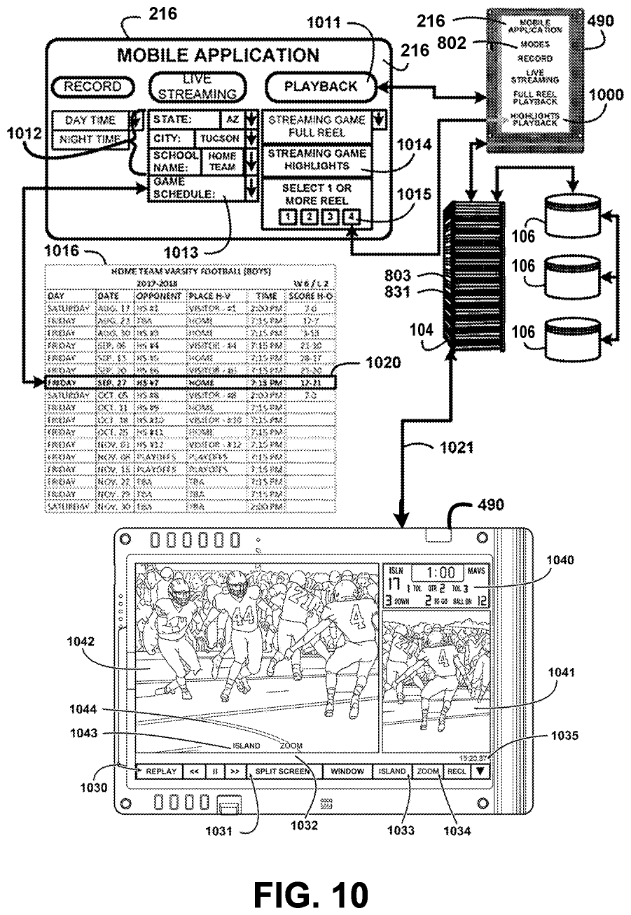

FIG. 10 shows for illustrative purposes only an example of highlights playback settings of one embodiment. FIG. 10 shows a subscribed viewer tablet 490 with the mobile application 216 modes including record, live-streaming, full reel playback and highlights playback are displayed on a home page from a website 803 on the remote computer server 104. The subscribed viewer can select highlights playback 1000 from the mobile application mode selection menu 920 in a playback 1011 mode. A subscribed viewer selects the state, city and school for playback 1012. The game schedule drop down shows the “home team” season game schedule 1013.

A subscribed viewer selects a game in which the home team lost 1020 from the home team season game schedule 1016. A selection of streaming game highlights is made 1014 along with a selection of camera #4 highlights is made 1015. The subscribed viewers’ selections are transmitted to the remote computer server 104. The remote computer server 104 downloads the selections where video camera #3 and #4 captured footage is recorded in a full reel database 660, video camera #2 auto highlight selections are recorded in a second auto highlights database 670, and video camera #1 auto highlight selections are recorded in a first auto highlights database 680.

The camera #4 highlights are transmitted to the viewers' digital device 1021 in this example a tablet 490. On the tablet 490 the subscribed viewer selects replay 1030, split screen 1031, slo-mo 1033 and zoom 1034. The playback 1011 mode displays a footage camera #4 footage timer 1032 and a scoreboard 1040 with game time elapsed 1035 in this example for the second quarter. The playback 1011 mode displays in the split screen 1031 mode the scoreboard 1040, unzoomed footage 1041, and a replay of auto highlight selection 1042. The replay of auto highlight selection 1042 screen shows replay slo-mo mode is displayed 1043 and replay zoom mode is displayed 1044 to alert the subscribed viewer those modes are selected. The subscribed viewer can unselect and reselect the modes at any time of one embodiment.

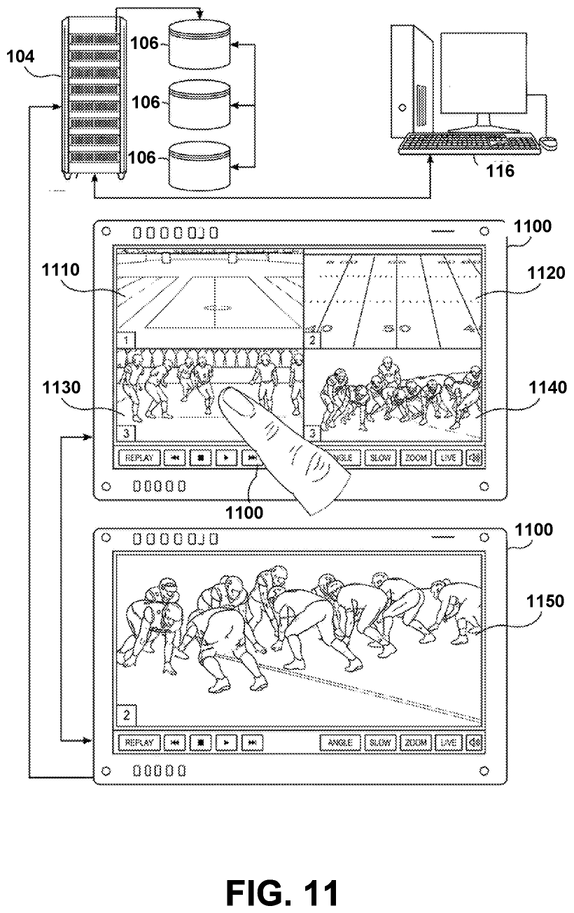

FIG. 11 shows for illustrative purposes only an example of split screen mode selection of one embodiment. FIG. 11 shows a cellular transmission from each camera is received by a network computer 620 coupled to the remote computer server 104 including a video recognition device 1115. The network computer 620 coupled to a remote computer server 104 receives from the remote computer server 104 video camera #3 and #4 captured footage is recorded in a full reel database 660, video camera #2 auto highlight selections are recorded in a second auto highlights database 670 and video camera #1 auto highlight selections are recorded in a first auto highlights database 680. The footage is shown on a subscribed viewers' tablet 490 including camera #1 live-streaming video 1110, camera #2 live-streaming video 1120, camera #3 live-streaming video 1130, and camera #4 live-streaming video 1140. The default live-streaming view is a split screen showing all four cameras views. A subscribed viewer taps the camera #3 view 1100 as cameras #1 and #2 are showing no action. The camera #3 view is enlarged to fill the screen as the subscribed viewer selected 1150 to better see the action showing in the camera #3 views. The subscribed viewer can tap both camera #3 and camera #4 and see a split view of both views simultaneously of one embodiment.

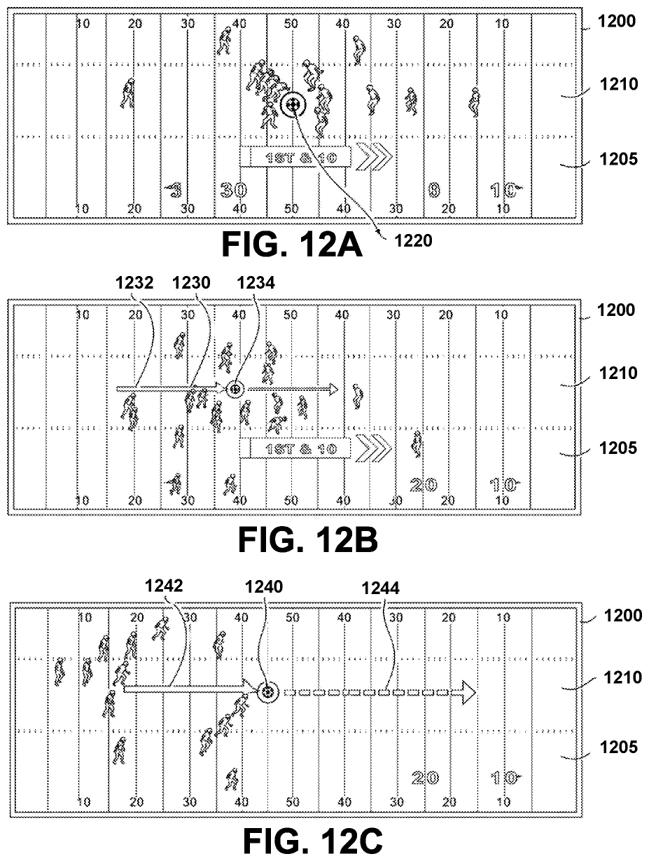

FIG. 12A shows for illustrative purposes only an example of auto cross camera first view action targeting of one embodiment. FIG. 12A shows where a camera #2 view is displayed with a matching overlay of a camera #1 view 1200. An electronic grid 1210 is superimposed by the remote computer server 104 of FIG. 1 which is not visible to the subscribed viewer. The electronic grid 1210 is used to track motion and speed of the action. The at least one digital processor 831 of FIG. 8 calculates motion by images passing through the grid. The electronic grid 1210 also provides a relative speed reference for calculating the relative speed of persons and objects on the field. The at least one video device 835 of FIG. 8 includes a video recognition device 1115 of FIG. 11.

One of the at least one digital database 830 of FIG. 8 includes data on basic sports equipment including footballs, baseballs, tennis balls, hockey pucks and others. These pieces of sports equipment are generally the focus of the action. The sizes, shapes and in some cases materials of these pieces of sports equipment are controlled by league, conference and international standards.

The video recognition device 1115 of FIG. 11 can download the size, shape and at least typical material color of the piece of sports equipment corresponding to the sports game being captured. The video recognition device 1115 of FIG. 11 can scan the views being received from the cameras and identify and locate the object matching the piece of sports equipment corresponding to the standard size, shape and color. The video recognition device 1115 of FIG. 11 can track the location of the for example baseball.

The video recognition device 1115 of FIG. 11 can track the movement of the baseball across the electronic grid 1210 and using the at least one digital processor 831 of FIG. 8 can calculate a projected path of the baseball. The distance the baseball is from the camera capturing its image can be calculated by the at least one digital processor 831 of FIG. 8 in a calculated range finder calculation by evaluating the size of the baseball image versus the standardized size. This calculated range finder value can be used to calculate a zooming setting to capture a closer view of the action surrounding the location of the baseball.

For example a baseball hit towards an outfield fence will appear to become visibly smaller. Activating the zoom mode using the calculated zooming setting can bring into better view an outfielders' attempt at catching the potential home run baseball. The projected path of the baseball allows for loss of visibility of the actual baseball and allows highlights selections to focus on the projected path until the baseball comes into visibility and can be identified by the video recognition device 1115 of FIG. 11 at which time a recalculated projected path can be determined.

In the football example the football recognition locates the position of the football on the line of scrimmage 1220. The remote computer server 104, at least one digital processor 831 of FIG. 8, at least one video device 835 of FIG. 8 and at least one OCR device 832 of FIG. 8 are used to identify matching points on the adjacent camera views. In this example the at least one OCR device 832 of FIG. 8 converts the 20 yard line into readable data on both the camera #2 and #1 view. The at least one video device 835 of FIG. 8 matches the identified 20 yard line images in an overlay. The at least one digital processor 831 of FIG. 8 calculates the electronic grid 1210 spacing to account for any approximations of the matched images. FIG. 12A shows the matching overlay line of camera #2 and camera #1 1205 and overlaid electronic grid 1210 of one embodiment.

FIG. 12B shows for illustrative purposes only an example of auto cross camera second view action targeting of one embodiment. FIG. 12B shows the camera #2 view is displayed with a matching overlay of a camera #1 view 1200 including the electronic grid 1210 and matching overlay line of camera #2 and camera #1 1205. The sports equipment recognition tracking device 822 of FIG. 8 has located the football 1230 at a newly calculated terminus of the previous path of the runner with the football 1232. The at least one digital processor 831 of FIG. 8 calculates a recalculated projected path and speed of the runner and football for auto highlight selection tracking 1234 of one embodiment.

FIG. 12C shows for illustrative purposes only an example of auto cross camera third view action targeting of one embodiment. FIG. 12C shows a camera #2 view is displayed with a matching overlay of a camera #1 view 1200, the electronic grid 1210 and matching overlay line of camera #2 and camera #1 1205. The sports equipment recognition tracking device 822 of FIG. 8 has located the football carried by the runner 1240 at the terminus of the previous path of the runner with the football 1242. The at least one digital processor 831 of FIG. 8 calculates a projected path and speed of the runner and football for auto highlight selection tracking across the matching overlay line of camera #2 and camera #1 1244 of one embodiment.

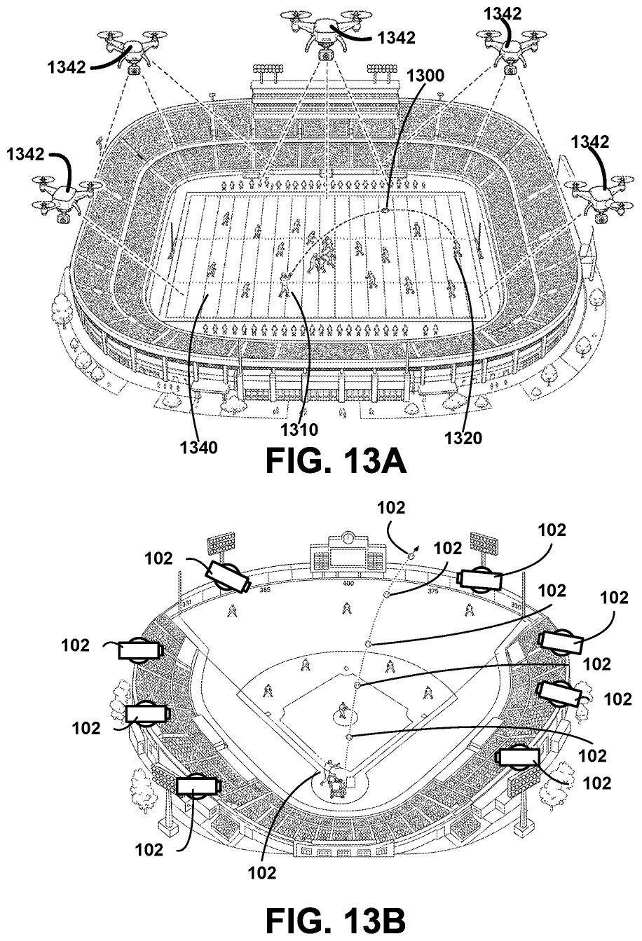

FIG. 13A shows for illustrative purposes only an example of auto drone camera streaming tracking of one embodiment. FIG. 13 shows the sports venue for example a high school football field 104, scoreboard 102, camera #1 with app installed 100, camera #2 with app installed 110, camera #3 with app installed 120, camera #4 with app installed 130, and two teams on the field shown in playbook format for illustration ease 600.

In one embodiment a drone 1342 with a video camera with the app installed is deployed during the game 1340. The drone 1342 camera image allows the sports equipment recognition tracking device 822 of FIG. 8 to locate the football on the line of scrimmage 1300. A quarterback passes the football 1302 to a receiver down field catches the football 1310. The receiver runs towards the corner of the end zone 1312 and two defenders run after the receiver 1314.

The drone 1342 receives the projected path and speed from the remote computer server 104 of FIG. 1 and flies the projected path 1350. The sports equipment recognition tracking device 822 of FIG. 8 locates the football being carried by the receiver 1320. The receiver runs approximately following the projected path 1322 and the receiver crosses the goal line 1330. The drone 1342 camera captures the touchdown from an aerial view 1360. The remote computer server 104 of FIG. 1 at least one digital processor 831 of FIG. 8 has detected the motion on the field and has added the drone 1342 aerial coverage to the auto highlight selection of one embodiment.

FIG. 13A shows, for illustrative purposes only, an example of an automated aerial multi-camera tracking system integrated with a ground-based multi-camera video analytics system, according to one embodiment. As shown on Sheet 13 of 19, a playing venue 1340 is monitored by a plurality of aerial drone cameras 1342 positioned above and around the playing venue 1340 to provide overlapping fields of view.

Each aerial drone camera 1342 captures continuous live-motion video images of athletes and a game object and transmits video data streams to a remote computer server 104 of FIG. 1A through a cloud 118 of FIG. 1A or other communication network. The remote computer server 104 of FIG. 1A receives the video data streams from the plurality of aerial drone cameras 1342 and synchronizes the video data streams with video data streams received from a plurality of ground-based video camera imaging devices 102 of FIG. 1A.

The synchronized video data streams are processed by a sports-equipment recognition and tracking device 822 of FIG. 8 to identify and track the game object across successive frames, including detection of an initial object position 1300, an intermediate object position 1310, and a subsequent object position 1320. A digital processor 831 of FIG. 8 processes the tracked object data to calculate movement parameters, including velocity, direction, and trajectory of the game object.

The digital processor 831 of FIG. 8 generates a projected trajectory path based on the initial object position 1300, the intermediate object position 1310, and the subsequent object position 1320, and continuously updates the projected trajectory path as new positional data is received. The remote computer server 104 of FIG. 1A transmits trajectory data and positional data to the plurality of aerial drone cameras 1342. Each aerial drone camera 1342 dynamically adjusts position, orientation, and imaging parameters based on the projected trajectory path to maintain continuous tracking of the game object.

The plurality of aerial drone cameras 1342 operate cooperatively to maintain overlapping coverage of the playing venue 1340 and to preserve visibility of the game object during gameplay.

The remote computer server 104 of FIG. 1A stores the video data streams, trajectory data, and associated metadata in a database 106 of FIG. 1A for later retrieval, analysis, and generation of replay and highlight content. Thus, the system shown in FIG. 13A provides integrated aerial and ground-based multi-camera video capture, real-time object tracking, trajectory analysis, and automated control of aerial imaging devices within a video analytics framework.

FIG. 13B shows, for illustrative purposes only, an example of a video-based multi-camera analytics system applied to a baseball game, according to one embodiment. As shown on Sheet 13 of 19, a baseball field is monitored by a plurality of video camera imaging devices 102 positioned at different locations around the baseball field to capture continuous live-motion video images of athletes and a baseball during gameplay.

The plurality of video camera imaging devices 102 captures a pitching sequence in which a pitcher delivers a pitch toward a batter positioned at home plate. The video camera imaging devices 102 transmit video data streams to a remote computer server 104 of FIG. 1A through a cloud 118 of FIG. 1A or other communication network. The remote computer server 104 receives the video data streams and generates synchronized video data streams corresponding to different camera views. The synchronized video data streams are stored in a database 106 of FIG. 1A for real-time processing and analysis.

A sports-equipment recognition and tracking device 822 of FIG. 8 analyzes the synchronized video data streams to identify and track the baseball during the pitch sequence. A digital processor 831 of FIG. 8 processes the tracked baseball data to determine pitch parameters, including release position, velocity, and trajectory of the baseball as the baseball travels from the pitcher toward the batter.

A video-recognition and tracking module 110 of FIG. 1A analyzes the synchronized video data streams to identify and track the batter and associated bat movement. An analytic tracking processor 112 of FIG. 1A processes the tracked player data to determine bat swing characteristics, including swing angle, swing velocity, and timing relative to the arrival of the baseball.

Upon bat-to-ball contact, the sports-equipment recognition and tracking device 822 of FIG. 8 confirms contact and continues to track the baseball as a batted object. The digital processor 831 of FIG. 8 determines an initial object position 1300, an intermediate object position 1310, and a subsequent object position 1320 of the baseball and generates an object trajectory path 1230 of FIG. 12.

The digital processor 831 of FIG. 8 calculates movement parameters, including exit velocity, launch angle, and projected trajectory of the baseball as the baseball travels into an outfield region. The object trajectory path 1230 of FIG. 12 is continuously updated based on new positional data received from the sports-equipment recognition and tracking device 822 of FIG. 8. The analytic tracking processor 112 of FIG. 1A simultaneously tracks the movement of the batter and fielders to generate a player movement path 1130 of FIG. 11 representing player positioning and movement relative to the object trajectory path 1230 of FIG. 12.

The remote computer server 104 of FIG. 1A combines the player movement path 1130 of FIG. 11 and the object trajectory path 1230 of FIG. 12 to generate integrated gameplay analytics representing interactions between the athletes and the baseball, including determination of a projected landing location and classification of the batted baseball as a potential home run event based on the projected trajectory.

The remote computer server 104 of FIG. 1A generates visual overlays representing the object trajectory path 1230 of FIG. 12 and the player movement path 1130 of FIG. 11 and transmits the visual overlays to a subscriber's digital device 218 for display. The subscriber's digital device 218 displays the synchronized video data streams with superimposed graphical representations of the object trajectory path 1230 of FIG. 12 and the player movement path 1130 of FIG. 11, including associated movement parameters.

The remote computer server 104 of FIG. 1A stores trajectory data, player tracking data, integrated analytics, and associated metadata in the database 106 of FIG. 1A for later retrieval, comparison, and performance analysis.

Thus, the system shown in FIG. 13B provides real-time multi-camera tracking, pitch analysis, bat swing analysis, ball trajectory prediction, player movement tracking, and integrated gameplay analytics for a baseball event.

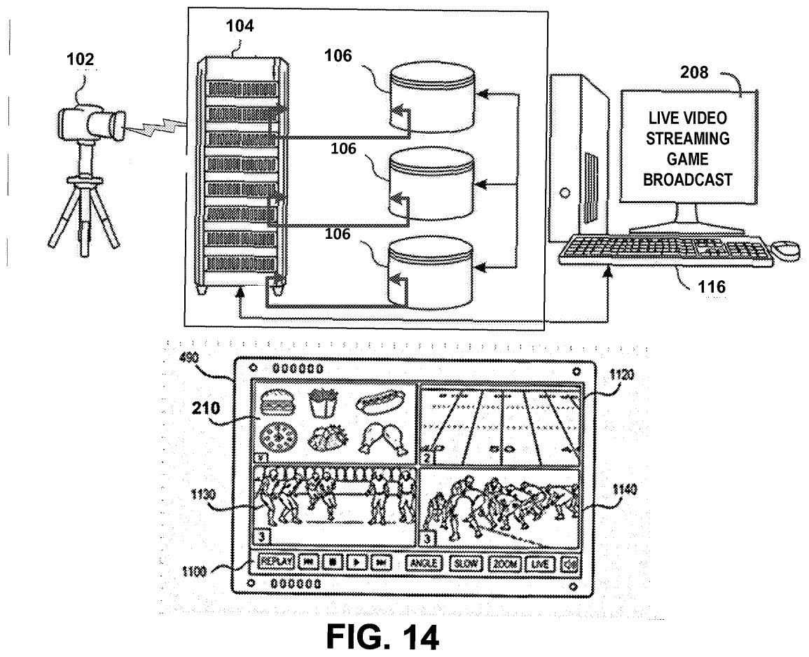

FIG. 14 shows for illustrative purposes only an example of auto ad mixing timing of one embodiment. FIG. 14 shows the camera #1 with mobile app installed 100, scoreboard 102, remote computer server 104, video camera #3 and #4 captured footage is recorded in a full reel database 660, video camera #2 auto highlight selections are recorded in a second auto highlights database 670 and video camera #1 auto highlight selections are recorded in a first auto highlights database 680. A cellular transmission of a mobile app live video streaming game broadcast 208 from each camera is received by a network computer 620 coupled to a remote computer server 104. A network computer 620 coupled to a remote computer server 104 receives a captured scoreboard image 1400 from the camera #1 mobile app live video streaming game 1402. The scoreboard image 1410 includes the game clock 1412.

When the game clock 1412 is stopped the remote computer server 104 processes the start of a split screen mode and displays the scoreboard and a camera section with no motion to use for advertising. Camera #2 live-streaming remains displayed 1460, camera #3 live-streaming remains displayed 1462 and camera #4 live-streaming remains displayed 1464 in the split screen 1031. The game clock image is processed 1414 using the at least one digital processor 831 and at least one OCR device 832. It is determined the game clock 1412 is stopped.

The at least one advertising database 842 downloads the advertising menu 1420 and displays the advertising menu wherein the subscribed viewer selects food service 1430. A subscribed viewer taps a finger on the pizza in the food service advertisers menu 1470. For the type of food the subscribed viewer selects the food service advertisers 210 in the locale are listed. The subscribed viewer pizza selection takes the viewer to the ordering process shown in FIG. 4. When the game clock 1412 begins to run again the mobile app live video streaming game broadcast 208 continues on the split screen as shown in FIG. 4 of one embodiment.

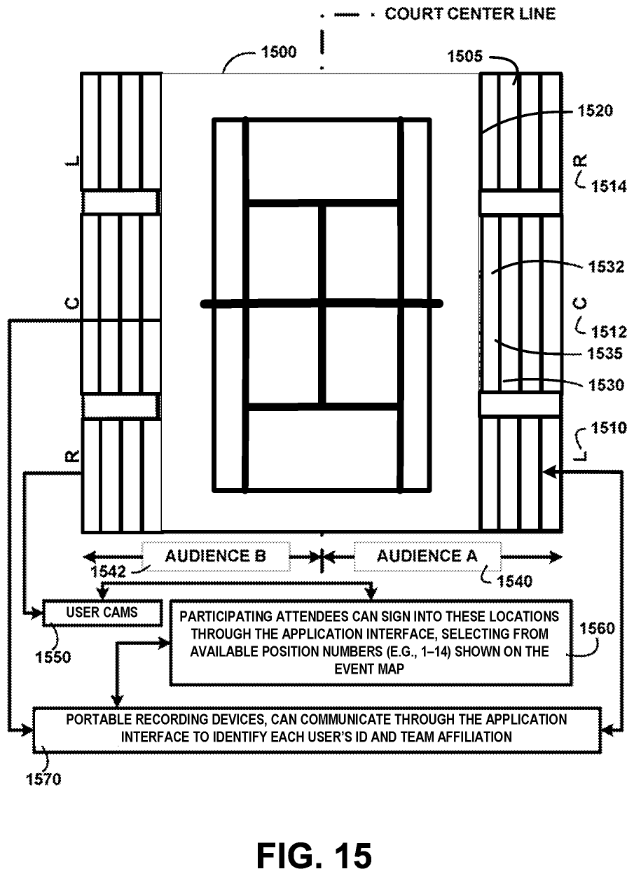

FIG. 15 shows for illustrative purposes only an example of an overview of cam user position selection of one embodiment. FIG. 15 shows a tennis court 1500 and grand stands 1505 for attendee seating. The remote computer server 104 of FIG. 1A can receive cellular video transmissions from at least one cam position 1520. The cellular video transmissions from the at least one cam position 1520 recorded in at least one database 106 of FIG. 1 of the remote computer server 104 of FIG. 1A of one embodiment.

The application 216 of FIG. 2 sets-up the venue location, designated camera locations and user selection sign-up of the camera locations prior to an event. A mobile application 216 user by selecting an event camera location grants the application permission to access the user camera device and captured video during the event until the user signs-out. The mobile application user also grants permission to locate the user and their device at the venue via a location finder and to identify the user by a unique ID assigned for the event and allows other mobile application users with event camera locations to ping and call them during the event. The application 216 of FIG. 2 can distinguish each assigned camera location user to one or more teams according to the camera location they have selected.

Each application user that has selected a camera position further agrees to abide by a application 216 of FIG. 2 code of conduct to conduct themselves in a manner that does not interfere with the event activities including not entering the playing field or court, engage in any uncivil conduct physical or verbal with any persons at the event, cooperate with coaches and officials directions and recognize their contribution to the event by making the capture videos available to the event participants and those that could not attend.

GPS coordinates for each assigned at least one cam position 1520 are calculated using at least one server digital processor 642 of FIG. 6 by scaling distances from a sports venue GPS locator GPS coordinate determination. Each of the at least one cam position 1520 can locate another cam position 1520 at the sports venue using the calculated GPS coordinates and pinging a unique ID assigned to each cam user at an event 1570. Each of the cam users when in position can broadcast the GPS location using the application 216 of FIG. 2 of their for example smart phone to the other cam users. The cam user's device GPS location can be displayed on the event sports venue display on the application 216 of FIG. 2 and identified by their assigned unique ID. One of the at least one cam position 1520 can be designated as an event cam coordinator position 1535. The user selecting the event cam coordinator position 1535 can communicate with the other cam users at the event to ensure coverage of the event. For example if one of the cam users has to unexpectedly leave the event early due to an emergency the event cam coordinator can request one of more of the remaining cam users to shift positions to roam with the action of the play.

Camera positions are divided between left L 1510, center C 1512 and right R 1514 areas of the tennis court 1500 side lines. A cam position 1520 is shown along with other positions a tennis match attendee can sign on for to capture video of the match for the live video streaming game broadcast 208 of FIG. 2. cam user positions are split into team A and team B according to which audience side of the court or field their camera position is located including audience A 1540 and audience B 1542. A team A bench 1530 and team B bench 1532 provides seating for the teams during breaks in the matches. cams 1550 can include a smart phone 800 of FIG. 8. Game attendees can ping each other and sign on to positions 1, 2, 3, 4, 5, . . . 12, 13, 14 . . . on either A or B side of field or court 1560. Cam users can ping another cam user using the unique ID assigned to each cam user at an event 1570 of one embodiment.

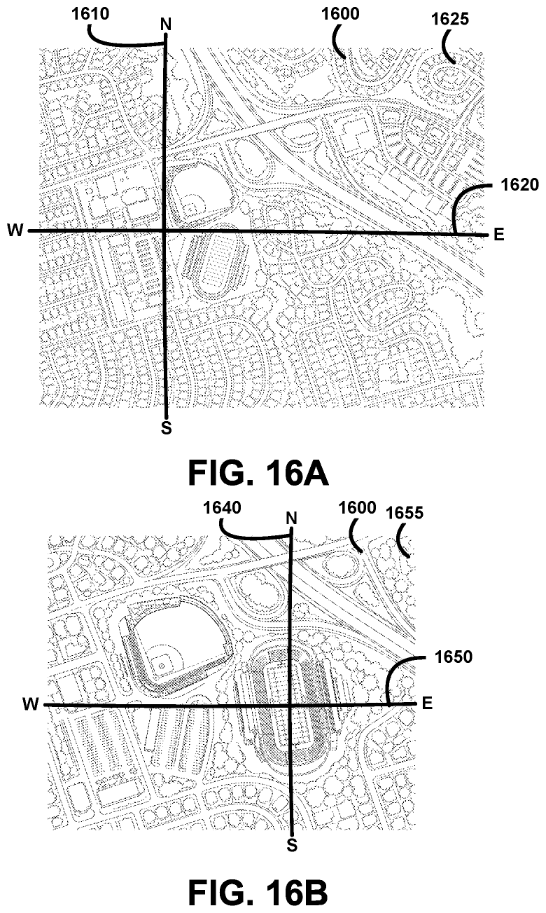

FIG. 16A shows for illustrative purposes only an example of a school location GPS search of one embodiment. FIG. 16A shows a school aerial map GPS location 1600 including a first North-South longitude GPS coordinate line 1610 and a first East-West latitude GPS coordinate line 1620. The crossing point of the first North-South longitude GPS coordinate line 1610 and the first East-West latitude GPS coordinate line 2620 is the location of the first GPS coordinates 2625 of one embodiment.

FIG. 16B shows for illustrative purposes only an example of a school sports venue locator of one embodiment. FIG. 16B shows a school football field aerial map GPS location 1630 found with a scan of the school aerial map GPS location 1600 of FIG. 16A which detected the football field. The detected school football field aerial map GPS location 1630 includes a second north-south longitude GPS coordinate line 1640 and second east-west latitude GPS coordinate line 1650. The crossing point of the second North-South longitude GPS coordinate line 1640 and the second East-West latitude GPS coordinate line 1650 is the location of the second GPS coordinates 1655 of the sports venue of one embodiment.

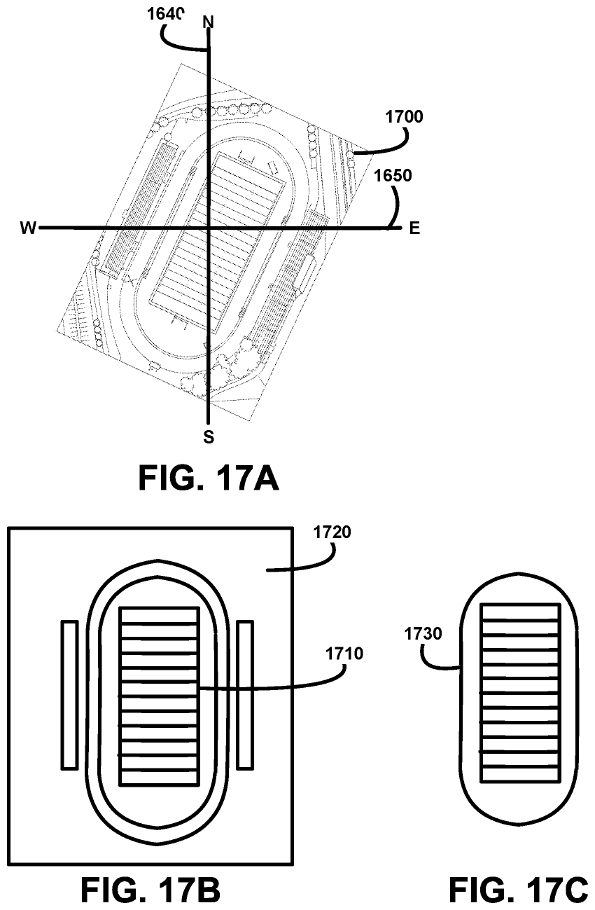

FIG. 17A shows for illustrative purposes only an example of a school football field sports venue identification of one embodiment. FIG. 17A shows a school football field aerial map GPS identification 1700 using the second north-south longitude GPS coordinate line 1640 and second east-west latitude GPS coordinate line 1650 using a sports venue recognition template 1730. The application 216 of FIG. 1 displays a sports venue recognition template 1730 overlay and can display the GPS coordinates for each assigned at least one cam position 1520 of FIG. 15 of one embodiment.

FIG. 17B shows for illustrative purposes only an example of a sports venue N-S orientation of one embodiment. FIG. 17B shows an N-S vertical orientation realignment 1720 of the school football field aerial map GPS identification 1700 of FIG. 17A. The N-S vertical orientation realignment 1720 is used with the matching football field grid lines to recognition template 1710 to assign camera positions at the identified sports venue for attendee sign-ons of one embodiment.

FIG. 17C shows for illustrative purposes only an example of a football field sports venue recognition template of one embodiment. FIG. 17C shows a football field recognition template 1730 used for identifying a football field sports venue. The application 216 of FIG. 1 displays a sports venue recognition template 1730 overlay and can display the GPS coordinates for each assigned at least one cam position 1520 of FIG. 15 of one embodiment.

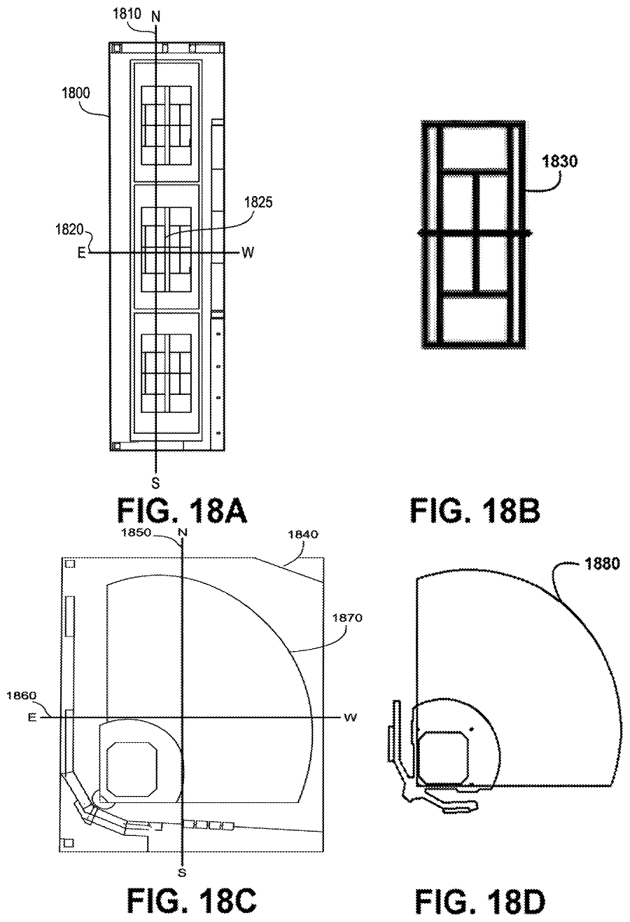

FIG. 18A shows for illustrative purposes only an example of a school tennis sports venue locator of one embodiment. FIG. 18A shows a school tennis court sports venue aerial map GPS location 1800 that has been vertically oriented. The school tennis court sports venue aerial map GPS location 1800 includes a tennis court north-south longitude GPS coordinate line 1810 and tennis court east-west latitude GPS coordinate line 1820. The courts have been identified using a matching tennis court lines to recognition template 1825 of one embodiment.

FIG. 18B shows for illustrative purposes only an example of a tennis court sports venue recognition template of one embodiment. FIG. 18B shows a tennis court recognition template 1830 used to identify the school tennis courts sports venue of one embodiment.

FIG. 18C shows for illustrative purposes only an example of a school baseball sports venue locator of one embodiment. FIG. 18C shows a school baseball field sports venue aerial map GPS location 1840 that has been vertically oriented. The school baseball field sports venue aerial map GPS location 1840 includes a baseball field north-south longitude GPS coordinate line 1850 and baseball field east-west latitude GPS coordinate line 1860. The baseball field has been identified using a matching baseball field lines to recognition template 1870 of one embodiment.

FIG. 18D shows for illustrative purposes only an example of a baseball field sports venue recognition template of one embodiment. FIG. 18D shows a baseball field recognition template 1880 used to identify the school baseball field sports venue of one embodiment.

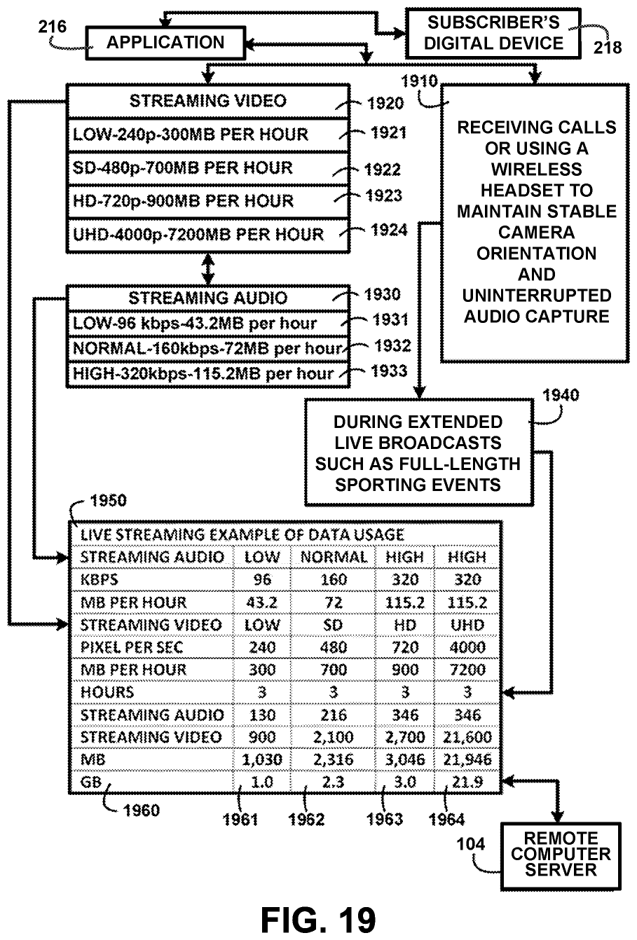

FIG. 19 shows for illustrative purposes only an example of live streaming example of data usage of one embodiment. FIG. 19 shows the app 180 used on a user digital device 1900. A user live streaming a high school football game can take calls while live streaming the game for example using a Bluetooth device so the smart phone camera stays aimed at the field 1910. For example smart phone and other digital devices are generally sign into a data service provider. Data service plans vary. A cam user can adjust the amount of data being used while capturing the live video streaming of an event.

Typical data usage rates per hour include for example streaming video 1920 at different quality definition level usage rates including LOW-240p-300 mb per hour 1921, SD-480p-700 mb per hour 1922, HD-720p-900 mb per hour 1923, UHD-4000p-7200 mb per hour 1924. Data use also includes streaming audio 1930 at different quality level usage rates per hour including low-96 kbps-43.2 mb per hour 1931, normal-160 kbps-72 mb per hour 1932, and high-320 kbps-115.2 mb per hour 1933. Live streaming a typical high school football game takes approximately 3 hours 1940.

The 3 hour duration of a typical high school football game puts a range of live streaming example of data usage 1950 in data units for example gigabits GB 1960 based on video quality including low, normal, high definition and ultra-high definition for averages including in GB 1.0 1961, 2.3 1962, 3.0 1963 and 21.9 1964. The cam user can determine the quality level to regulate the data usage to avoid additional charges from their data service provider. The live video streaming game broadcast 208 of FIG. 2 is recorded and stored in databases at the quality level set by the cam user in the remote computer server 104 of one embodiment.

FIG. 21 shows for illustrative purposes only an example of soccer ball tracking from the video camera captured images during play of one embodiment. FIG. 21 shows the sports venue recognition template 1730 showing a soccer field. FIG. 21 shows further shows the soccer field sidelines 2010, goals, other line markings. Also shown positioned around each side and ends of the soccer field are a series of multi-camera live-streaming video cameras including smart phone cameras with overlapping fields of view. The positioned live-streaming video cameras include for example, five live-streaming video cameras including camera with app 2020, camera with app 2021, camera with app 2022, camera with app 2023, and camera with app 2024. At a first goal end of the soccer field is at least one live-streaming video camera with app 2025 to capture the goal shots and defense. On the opposite side are, for example, camera with app 2030, camera with app 2031, camera with app 2032, camera with app 2033, and camera with app 2034. At the second goal end of the soccer field is at least one live-streaming video camera with app 2035 to capture the goal shots and defense to capture overlapping video coverage.

An electronic grid 1210 is overlaid on the soccer field. The electronic grid 1210 is superimposed by the remote computer server 104 of FIG. 1 which is not visible to the subscribed viewer. The electronic grid 1210 is used to track motion and speed of the action. The at least one digital processor 831 of FIG. 8 calculates motion by images passing through the grid. The electronic grid 1210 also provides a relative speed reference for calculating the relative speed of persons and objects on the field. The at least one video device 835 of FIG. 8 includes a video recognition device 1115 of FIG. 11.

The video recognition device 1115 of FIG. 11 recognizes the soccer ball and tracks its movements. In one embodiment the current sports equipment being used is photographed in the current event and stored in the video recognition device database with data on dimensions, weight and identification of any outstanding characteristics including baseball stitching, football laces and other unique attributes. FIG. 21 shows a first position of the soccer ball 2110 on the field. A soccer player may kick the soccer ball to another player down field. The path and vertical arc the soccer ball is moving to a second position 2120 shown at the second position of the soccer ball. 2130. The spacing of the electronic grid lines are uniform and the calculations include the time the soccer ball travels from one electronic grid line to the next to determine its speed. The calculation of the total distance traveled in this kick is calculated based on the tracked movement across each grid section and totaled of one embodiment.

FIG. 22 shows for illustrative purposes only an example of baseball tracking from the video camera captured images during play of one embodiment. FIG. 22 shows the sports venue recognition template 1730 for a baseball field. The baseball field sports venue recognition template 1730 shows, for example, the baseball first base foul line 2260, third base foul line 2262 and the outfield perimeter line, other line markings including homebase, base locations and the infield. Also shown positioned around the baseball field are a series of multi-camera live-streaming video cameras including smart phone cameras with overlapping fields of view. The positioned live-streaming video cameras include for example, camera with app 2210, camera with app 2211, camera with app 2212, and camera with app 2213 along the first base foul line. Another group of positioned live-streaming video cameras include, for example, camera with app 2220, camera with app 2221, camera with app 2222, and camera with app 2223 along the third base foul line. Along the perimeter of the outfield are positioned live-streaming video cameras include, for example, camera with app 2230, camera with app 2231, camera with app 2232, and camera with app 2233. The plurality of positioned live-streaming video cameras are processed to show overlapping video coverage of the entire baseball field.

The plurality of live-streaming video cameras are transmitting in real-time to a remote computer server 104 of FIG. 1. The remote computer server 104 of FIG. 1 records all of the live-streaming video camera images on at least one database 158 of FIG. 1 of the remote computer server 104 for future replay and further processing. The video transmissions are processed in the remote computer server 104 of FIG. 1 to send live streaming videos through an internet signal transmitter 232 of FIG. 2 and internet signal 262 of FIG. 1 through commercial communications networks. A live video streaming game broadcast 208 of FIG. 2 can be seen on a plurality of digital devices using a subscribed viewer digital device with the app installed 170 of FIG. 1

The at least one video device 835 of FIG. 8 includes a video recognition device 1115 of FIG. 11. The video recognition device 1115 of FIG. 11 recognizes the baseball and tracks its movements. In one embodiment the current sports equipment being used is photographed in the current event and stored in the video recognition device database with data on dimensions, weight and identification of any outstanding characteristics including baseball stitching, football laces and other unique attributes. An electronic grid 1210 is showing extending from home plate a plurality of radial electronic grid lines 2202 and home plate centered radius arc electronic grid lines 2204. FIG. 22 shows a first position of the baseball 2240 at home plate. The batter hits the baseball into the center of left field into a second position of the baseball 2250. The path and vertical arc the baseball is moving to the second position 2260. The electronic grid 1210 is superimposed by the remote computer server 104 of FIG. 1 which is not visible to the subscribed viewer.

The electronic grid 1210 is used to track motion and speed of the action. The at least one digital processor 831 of FIG. 8 calculates motion by images passing through the electronic grid. The electronic grid 1210 also provides a relative speed reference for calculating the relative speed of persons and objects on the field.

The spacing of the both radial electronic grid lines 2202 and home plate centered radius arc electronic grid lines 2204 is uniform and the calculations include the time the soccer ball travels from one electronic grid line to the next to determine its speed. The calculation of the total distance traveled in this batted baseball is calculated based on the tracked movement across each grid section and totaled of one embodiment.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A video-based analytics system for automatically detecting, measuring, evaluating, and analyzing gameplay activity during a live sporting event, the system comprising:
a plurality of video cameras positioned at different physical locations and oriented at distinct vantage points of the sporting event, each camera configured to capture continuous live-motion video images of athletes participating in the live sporting event and at least one corresponding piece of sports equipment during the sporting event;
a remote computer server configured to receive and process the continuous live-motion video images and to generate synchronized video data streams;
a video-recognition and tracking device coupled to the remote computer server and configured to analyze the synchronized video data streams to automatically identify, segment, classify, and track location, orientation, speed, movement trajectory, and movement data associated with the at least one corresponding piece of sports equipment during the sporting event;
an analytics processor coupled to the remote computer server and configured to calculate, in real time, projected movement paths, projected travel distances, spatial locations, interaction locations, and movement trajectory data associated with the at least one corresponding piece of sports equipment during the sporting event;
a predictive analytics processor coupled to the remote computer server configured to evaluate and compare the synchronized video data streams to historical datasets stored in a database to determine quantifiable variations and differences between the synchronized video data streams and the historical datasets;
wherein the predictive analytics processor is further configured to determine movement paths, spatial locations, and movement trajectory data associated with the at least one corresponding the piece of sports equipment relative to one or more predefined gameplay regions based on the quantifiable variations and differences between the synchronized video data streams and the historical datasets; and
a graphical user interface coupled to the remote computer server and configured to display in real time visual representations, numerical representations, projected movement paths as three-dimensional graphical visualizations associated with the synchronized video data streams.

2. The video-based analytics system for automatically detecting, measuring, evaluating, and analyzing gameplay activity during a live sporting event of claim 1, wherein the predictive analytics processor is further configured to determine movement paths, spatial locations, and movement trajectory data associated with the participating athletes relative to the one or more predefined gameplay regions based on the differences between the synchronized video data streams and the historical datasets.

3. The video-based analytics system for automatically detecting, measuring, evaluating, and analyzing gameplay activity during a live sporting event of claim 1, wherein the plurality of video cameras are configured to operate such that their respective captured video streams collectively provide overlapping visual coverage of the sporting event.

4. The video-based analytics system for automatically detecting, measuring, evaluating, and analyzing gameplay activity during a live sporting event of claim 1, wherein the video-recognition and tracking module is further configured to continuously operate across successive image frames from different cameras to maintain identification of participating athletes and the at least one corresponding piece of sports equipment during the sporting event.

5. The video-based analytics system for automatically detecting, measuring, evaluating, and analyzing gameplay activity during a live sporting event of claim 1, wherein the predictive analytics processor is further configured to determine projected movement data associated with the participating athletes and the at least one corresponding piece of sports equipment during the sporting event.

6. The video-based analytics system for automatically detecting, measuring, evaluating, and analyzing gameplay activity during a live sporting event of claim 1, wherein the predictive analytics module further comprises an artificial-intelligence-based event detection and segmentation subsystem configured to analyze live video streams from the plurality of video cameras in real time to identify, label, classify, and store gameplay activity data associated with the sporting event.

7. The video-based analytics system for automatically detecting, measuring, evaluating, and analyzing gameplay activity during a live sporting event of claim 1, wherein the remote computer server is further configured to temporally associate corresponding image frames from the plurality of video cameras with one another to enable synchronized multi-view analysis of the sporting event.

8. The video-based analytics system for automatically detecting, measuring, evaluating, and analyzing gameplay activity during a live sporting event of claim 1, wherein the predictive analytics processor is further configured to compare current gameplay activity associated with the participating athletes and the at least one corresponding piece of sports equipment to previously analyzed gameplay activity stored in the database.

9. The video-based analytics system for automatically detecting, measuring, evaluating, and analyzing gameplay activity during a live sporting event of claim 1, wherein the graphical user interface is further configured to display synchronized replay data, graphical overlays, or rendered graphical visualizations generated from the synchronized video data streams during or after the sporting event.

10. A video-based analytics system for automatically detecting, measuring, evaluating, and analyzing gameplay activity during a live sporting event, the system comprising:
a plurality of video cameras positioned at different physical locations and oriented at distinct vantage points of the sporting event, each camera configured to capture continuous live-motion video images of athletes participating in the live sporting event and at least one corresponding piece of sports equipment during the sporting event;
a remote computer server configured to receive and process the continuous live-motion video images and to generate synchronized video data streams;
a video-recognition and tracking device coupled to the remote computer server and configured to analyze the synchronized video data streams to automatically identify, segment, classify, and track location, orientation, speed, movement trajectory, and movement data associated with the at least one corresponding piece of sports equipment during the sporting event;
an analytics processor coupled to the remote computer server and configured to calculate, in real time, projected movement paths, projected travel distances, spatial locations, interaction locations, and movement trajectory data associated with the participating athletes and the at least one corresponding piece of sports equipment during the sporting event;
a predictive analytics processor coupled to the remote computer server configured to evaluate and compare the synchronized video data streams to historical datasets stored in a database to determine quantifiable variations and differences between the synchronized video data streams and the historical datasets;
wherein the predictive analytics processor is further configured to determine movement paths, spatial locations, and movement trajectory data associated with the participating athletes and the at least one corresponding the piece of sports equipment relative to one or more predefined gameplay regions based on the quantifiable variations and differences between the synchronized video data streams and the historical datasets; and
a graphical user interface coupled to the remote computer server and configured to display in real time visual representations, numerical representations, projected movement paths as three-dimensional graphical visualizations associated with the synchronized video data streams.

11. The video-based analytics system for automatically detecting, measuring, evaluating, and analyzing gameplay activity during a live sporting event of claim 10, wherein the plurality of video cameras are configured to operate such that their respective captured video streams collectively provide overlapping visual coverage of the sporting event.

12. The video-based analytics system for automatically detecting, measuring, evaluating, and analyzing gameplay activity during a live sporting event of claim 10, wherein the video-recognition and tracking module is further configured to continuously operate across successive image frames from different cameras to maintain identification of participating athletes and the at least one corresponding piece of sports equipment during the sporting event.

13. The video-based analytics system for automatically detecting, measuring, evaluating, and analyzing gameplay activity during a live sporting event of claim 10, wherein the predictive analytics processor is further configured to determine projected movement data associated with the participating athletes and the at least one corresponding piece of sports equipment during the sporting event.

14. The video-based analytics system for automatically detecting, measuring, evaluating, and analyzing gameplay activity during a live sporting event of claim 10, wherein the predictive analytics module further comprises an artificial-intelligence-based event detection and segmentation subsystem configured to analyze live video streams from the plurality of video cameras in real time to identify, label, classify, and store gameplay activity data associated with the sporting event.

15. The video-based analytics system for automatically detecting, measuring, evaluating, and analyzing gameplay activity during a live sporting event of claim 1, wherein the remote computer server is further configured to temporally associate corresponding image frames from the plurality of video cameras with one another to enable synchronized multi-view analysis of the sporting event.

16. A video-based analytics system for automatically detecting, measuring, evaluating, and analyzing gameplay activity during a live sporting event, the system comprising:
a plurality of video cameras positioned at different physical locations and oriented at distinct vantage points of the sporting event, each camera configured to capture continuous live-motion video images of athletes participating in the live sporting event and at least one corresponding piece of sports equipment during the sporting event;
a remote computer server configured to receive and process the continuous live-motion video images and to generate synchronized video data streams;
a video-recognition and tracking device coupled to the remote computer server and configured to analyze the synchronized video data streams to automatically identify, segment, classify, and track location, orientation, speed, movement trajectory, and movement data associated with the athletes participating in the live sporting event and the at least one corresponding piece of sports equipment during the sporting event;
an analytics processor coupled to the remote computer server and configured to calculate, in real time, projected movement paths, projected travel distances, spatial locations, interaction locations, and movement trajectory data associated with the athletes participating in the live sporting event and the at least one corresponding piece of sports equipment during the sporting event;
a predictive analytics processor coupled to the remote computer server configured to evaluate and compare the synchronized video data streams to historical datasets stored in a database to determine quantifiable variations and differences between the synchronized video data streams and the historical datasets;
wherein the predictive analytics processor is further configured to determine movement paths, spatial locations, and movement trajectory data associated with the athletes participating in the live sporting event and the at least one corresponding the piece of sports equipment relative to one or more predefined gameplay regions based on the quantifiable variations and differences between the synchronized video data streams and the historical datasets; and
a graphical user interface coupled to the remote computer server and configured to display in real time visual representations, numerical representations, projected movement paths as three-dimensional graphical visualizations associated with the synchronized video data streams.

17. The video-based analytics system for automatically detecting, measuring, evaluating, and analyzing gameplay activity during a live sporting event of claim 16, wherein the plurality of video cameras are configured to operate such that their respective captured video streams collectively provide overlapping visual coverage of the sporting event.

18. The video-based analytics system for automatically detecting, measuring, evaluating, and analyzing gameplay activity during a live sporting event of claim 16, wherein the video-recognition and tracking module is further configured to continuously operate across successive image frames from different cameras to maintain identification of participating athletes and the at least one corresponding piece of sports equipment during the sporting event.

19. The video-based analytics system for automatically detecting, measuring, evaluating, and analyzing gameplay activity during a live sporting event of claim 16, wherein the predictive analytics processor is further configured to determine projected movement data associated with the participating athletes and the at least one corresponding piece of sports equipment during the sporting event.

20. The video-based analytics system for automatically detecting, measuring, evaluating, and analyzing gameplay activity during a live sporting event of claim 16, wherein the predictive analytics module further comprises an artificial-intelligence-based event detection and segmentation subsystem configured to analyze live video streams from the plurality of video cameras in real time to identify, label, classify, and store gameplay activity data associated with the sporting event.
